(19) United States
(12) Patent Application Publication
(10) Pub. No.: US 2023/0417184 A1
(43) Pub. Date: Dec. 28, 2023

(54) ENGINES

(71) Applicant: Reaction Engines Limited, Abingdon, Oxfordshire (GB)

(72) Inventors: Alan Bond, Abingdon (GB); Richard Varvill, Abingdon (GB); Edward Gower, Abingdon (GB); Martin Dodds, Abingdon (GB)

(73) Assignee: Reaction Engines Limited, Abingdon, Oxfordshire (GB)

(21) Appl. No.: 18/038,819

(22) PCT Filed: Nov. 26, 2021
(86) PCT No.: PCT/EP2021/083251

§ 371 Date: May 25, 2023

(30) Foreign Application Priority Data
Nov. 27, 2020 (GB) 2018754.8

(51) Int. Cl. F02C 7/057; F02C 7/042

(52) U.S. Cl. CPC F02C 7/057; F02C 7/042; F05D 2210/43

(57) ABSTRACT

An engine comprises an air inlet configured to receive air; a first heat exchanger arrangement arranged downstream of the air inlet, having a first heat exchanger inlet configured to receive at least a portion of the air received by the air inlet, and being configured to cool the air received by the first heat exchanger inlet; one or more turbomachinery components arranged downstream of an outlet of the first heat exchanger arrangement, and being configured to receive air; a first flow path arranged to extend from the air inlet to the first heat exchanger inlet; a second flow path arranged to extend from the air inlet to the one or more turbomachinery components, the second flow path bypassing the first heat exchanger inlet; and a flow control arrangement comprising a first portion and a second portion, the first and second portions being configured to be movable relative to one another to selectively obstruct the second flow path.

### FIELD

The present disclosure relates to engines, in particular precooled engines, such as of the type which may be used in aerospace applications, and to methods of operating such engines. The present disclosure also relates to aircraft, flying machines and aerospace vehicles comprising such engines.

### BACKGROUND

Efficient air-breathing propulsion for flight from low speed to high Mach (e.g. above Mach 2.5) can require the integration of several engine types (for example, an air-breathing engine and a rocket engine, or a turbomachinery based engine and a ramjet) into a single system, with carefully managed transitions between the various modes of operation provided by the different engine types, as thrust falls in one mode while thrust in another mode rises. The Mach number at which these transitions between different modes of operation occurs is largely a result of temperature limitations. For example, where a system is configured to operate using turbomachinery and a ramjet, typically there will be a transition from turbomachinery to ramjet operation at a flight speed where neither mode is optimised. This is because if, for example, material temperature limits in the turbomachinery are hit early and throttling thus occurs at lower supersonic speeds, well before the ramjet kicks in to produce good thrust performance, this results in a gap/deficiency in overall thrust performance, in which the propulsion system struggles to provide sufficient thrust to continue acceleration. If the temperature of the intake air entering the engine could be controlled (i.e. reduced below stagnation), then the transition point for a given engine mode could be at higher Mach. This would allow the various engine modes to be better optimised, and for greater flexibility of operation through the transition speeds. It could even allow for some engine modes to be removed completely. One means to achieve control of the air temperature entering the engine is by precooling using a heat exchanger (a “precooler”).

High Mach/hypersonic platforms are anticipated to employ precooled turbofan/jet engines for primary vehicle propulsion. A conventional turbofan or jet engine in isolation cannot typically reach hypersonic velocities due to the elevated enthalpy of the freestream flow causing the engine's operation to be restricted by practical limitations, such as a compressor's temperature limits. The use of a precooler allows the inlet flow to be cooled such that the turbofan/jet may be run at both subsonic flight velocities and at velocities which are beyond its typical operating envelope. By extending this envelope to high Mach regimes, the propulsion system will then be able to undertake a mode transition whereby a ramjet is activated within the bounds of efficient space envelope and performance. This can provide a flexible operation since the engine may operate in any mode and also transition between them. However, the use of a precooler can cause increased pressure losses, resulting in engine efficiency losses.

The present disclosure seeks to alleviate, at least to a certain degree, the problems and/or address at least to a certain extent, the difficulties associated with the prior art.

### SUMMARY

According to a first aspect of the disclosure, there is provided an engine comprising: an air inlet configured to receive air; a first heat exchanger arrangement arranged downstream of the air inlet, having a first heat exchanger inlet configured to receive at least a portion of the air received by the air inlet, and being configured to cool the air received by the first heat exchanger inlet; one or more turbomachinery components arranged downstream of an outlet of the first heat exchanger arrangement, and being configured to receive air; a first flow path arranged to extend from the air inlet to the first heat exchanger inlet; a second flow path arranged to extend from the air inlet to the one or more turbomachinery components, the second flow path bypassing the first heat exchanger inlet; and a flow control arrangement comprising a first portion and a second portion, the first and second portions being configured to be movable relative to one another to selectively obstruct the second flow path.

Advantageously, such an engine can provide that when operating at relatively high flight speeds, for example above approximately Mach 1.5, substantially all of the air entering the engine via the air inlet is caused to flow along the first flow path such that it is caused to enter the first heat exchanger, to be precooled therein; and when operating at relatively low flight speeds, for example at or below approximately Mach 1.5, for example at subsonic flight speeds, that a first portion of the air entering the engine via the air inlet is caused to flow along the first flow path such that it is caused to be precooled in the first heat exchanger, whilst a second portion of the air entering the engine via the air inlet is caused to flow along the second flow path such that it is caused to bypass the first heat exchanger to not be precooled therein. For example, at a low flight speed that is between subsonic to approximately Mach 1.5, full precooling of all of the air flow is not needed, and it would be more efficient to precool only a portion of the air, to advantageously reduce the total inlet pressure loss at such lower flight speeds, resulting in a more efficient engine. At such low flight speeds, the second flow path may thus advantageously provide for a portion of the air flow to bypass the first heat exchanger arrangement. At higher flight speeds, for example above approximately Mach 1.5, the flow control arrangement may advantageously provide for the second flow path to be obstructed/blocked, by movement of the first and second portions thereof, to cause substantially none of the air flow to bypass the first heat exchanger arrangement. Advantageously, the relatively movable first and second portions of the flow control arrangement can provide for this as they are configured to selectively obstruct the second flow path. By providing for selective/optional precooler bypassing/circumvention, such an engine may advantageously be employed in high Mach/hypersonic platforms with improved efficiency, by reducing pressure losses and increasing the pressure recovery factor (PRF).

Optionally, said first and second portions are movable relative to one another to provide at least one inlet flow aperture into the second flow path upstream of the first heat exchanger inlet.

Advantageously, such a flow control arrangement can selectively provide for the second flow path, to permit at least a portion of the air entering the engine via the air inlet, when the engine is in use, to bypass the precooler. In designing the engine, the size of the at least one inlet flow aperture may be chosen to determine the relative ratio between the amount of air received by the air inlet which may flow along the first flow path, and the amount of air received by the air inlet which may flow along the second flow path when the second flow path is un-obstructed.

Optionally, the engine is configured to be operated in a first mode at a first operating flight speed, and in a second mode at a second operating flight speed, wherein the second operating flight speed is greater than the first operating flight speed, and wherein said first and second portions are configured to be moved to selectively obstruct the second flow path when the engine is operating in the second mode, and wherein the first and second portions are configured to provide the at least one inlet flow aperture into the second flow path when the engine is operating in the first mode.

Advantageously, such an engine can provide that at lower flight speeds, a portion of the air flow bypasses the first heat exchanger arrangement, to reduce pressure losses, resulting in improved engine efficiency.

Optionally, the first operating flight speed is between approximately Mach 1 to Mach 3 and/or the second operating flight speed is between approximately Mach 1 to Mach 3. Optionally, the first operating flight speed is less than approximately Mach 1.5, and the second operating flight speed is greater than or equal to approximately Mach 1.5.

Optionally, the flow control arrangement is configured to be arranged in a first position in which the first portion and the second portion are arranged to provide the at least one inlet flow aperture, and a second position in which the first portion and the second portion are arranged to obstruct the at least one inlet flow aperture. The first and second positions may be referred to as “open” and “closed” positions respectively of the flow control arrangement, such that when the flow control arrangement is “open”, air is permitted to flow along the second flow path to bypass the first heat exchanger arrangement, and when the flow control arrangement is “closed”, air is prevented from flowing along the second flow path.

Optionally, the first portion and the second portion are configured such that when the flow control arrangement is in the first “open” position and the engine is in use, a first portion of the air entering the engine via the air inlet is caused to flow along the first flow path, and a second portion of the air entering the engine via the air inlet is caused to flow along the second flow path.

Optionally, the first portion of air may comprise between approximately 50% to 95% of the air entering the engine via the air inlet, and/or the second portion of air may comprise between approximately 5% to 50% of the air entering the engine via the air inlet. For example, the first portion of air may comprise approximately 70% of the air entering the engine via the air inlet, and the second portion of air may comprise approximately 30% of the air entering the engine via the air inlet.

Optionally, the flow control arrangement is configured to be arranged in one or more intermediate positions between the first and second positions, wherein in one or more of said intermediate positions, the first and second portions are arranged to at least partially obstruct the second flow path.

Optionally, the flow control arrangement is arranged downstream of the air inlet.

Optionally, the air inlet is configured for the flow of subsonic, supersonic and/or hypersonic air.

Optionally, the air inlet, the flow control arrangement, the first heat exchanger arrangement and the one or more turbomachinery components are arranged along and to be centred on a longitudinal axis of the engine. The longitudinal axis of the engine may be at least partially curved.

Optionally, the one or more turbomachinery components comprises a compressor. The one or more turbomachinery components may further comprise a turbine configured to drive the compressor. Optionally, the engine further comprises an air-breathing combustion chamber configured to receive compressed air from the compressor and for the combustion of air and fuel. The engine may further comprise an augmentation system such as a reheat or afterburner system. The engine may further comprise one or more exhaust nozzles, such as one or more variable area nozzles.

The engine may comprise an air-breathing jet engine, wherein the one or more turbomachinery components may comprise a compressor and a turbine.

Optionally, said first and second portions are configured to be movable relative to one another axially along a longitudinal axis of the engine, rotationally about said longitudinal axis and/or pivotally, to provide for said at least one inlet flow aperture.

Optionally, said first and second portions are arranged concentrically relative to one another with respect to a longitudinal axis of the engine and are movable relative to one another along said longitudinal axis to provide for said at least one inlet flow aperture.

Optionally, the at least one inlet flow aperture comprises an annular gap between the first and second portions.

Advantageously, the at least one inlet flow aperture comprising an annular gap can provide for air to flow along the second flow path with minimal flow turning required, thus preserving the dynamic head of the flow and hence minimising pressure losses, resulting in improved engine efficiency.

Optionally, said first and second portions are shaped such that when the flow control arrangement is in the second “closed” position, the first and second portions together form a generally continuous generally conical shaped structure, with no annular gap therein, i.e. with no annular gap between the first and second portions.

Advantageously, such a flow control arrangement may be configured to slow down the flow of incoming air received by the air inlet, for example to slow it from a supersonic flight speed to a subsonic flight speed, causing a conical shock wave to form at the apex of the conical shaped structure.

Optionally, said first portion is generally conical and is arranged concentrically inside the second portion, which is generally annular and comprises an outer surface that is generally in the form of a truncated cone. Optionally, the first portion is configured to be movable relative to the second portion with respect to the longitudinal axis of the engine, or vice versa. Optionally, the first portion is at least partially hollow. Optionally, the first portion is filled with a honeycomb filler material, to advantageously improve its specific stiffness properties.

Optionally, said first and second portions are shaped such that when the first portion or the second portion is moved towards the air inlet (i.e. in the upstream/forwards direction), an outer surface of the first portion is arranged to bear against an inner surface of the second portion to obstruct the second flow path, and conversely when the same one of the first portion or the second portion is moved away from the air inlet (i.e. in the downstream/rearwards direction), said annular gap is provided between the outer surface of the first portion and the inner surface of the second portion.

Optionally, said first and second portions are shaped such that when the first portion or the second portion is moved away from the air inlet (i.e. in the downstream/rearwards direction), an outer surface of the first portion is arranged to bear against an inner surface of the second portion to obstruct the second flow path, and conversely when the same one of the first portion or the second portion is moved towards the air inlet (i.e. in the upstream/forwards direction), said annular gap is provided between the outer surface of the first portion and the inner surface of the second portion.

Optionally, said first portion comprises at least one vane configured to be pivotable relative to said second portion, in order to provide for the at least one inlet flow aperture.

Optionally, said at least one vane is configured to be moved into a closed position in which said at least one vane is arranged to obstruct the second flow path, and an open position in which said at least one vane is arranged to provide the at least one inlet flow aperture.

Optionally, said first portion comprises a plurality of vanes angularly spaced apart from one another about a longitudinal axis of the engine. Optionally, each of the vanes is hingedly connected to a relatively fixed portion of the first portion to provide for pivotal movement of each of the respective vanes relative to the relatively fixed portion of the first portion and also relative to said second portion.

Optionally, said first and second portions are arranged concentrically relative to one another with respect to a longitudinal axis of the engine, the first portion comprising at least one first aperture and the second portion comprising at least one second aperture, the first and second portions being rotatable relative to one another about said longitudinal axis to align said at least one first aperture with said at least one second aperture to provide the at least one inlet flow aperture.

Optionally, said first and second portions are generally conical and are shaped to generally correspond with one another, such that by being arranged concentrically relative to one another, one of the first and second portions is nested inside the other one of the first and second portions. Optionally, the first and second portions are rotatable relative to one another into a first “closed” position in which the at least one first and second apertures are arranged to be misaligned with respect to one another, to obstruct the second flow path, and into a second “open” position in which they are aligned with respect to one another to provide the at least one inlet flow aperture. Optionally, the at least one first and second apertures each comprises a slot, the slots being angularly spaced apart from one another relative to the longitudinal axis of the engine. Optionally, the at least one first apertures cover/extend over approximately half of the circumference or surface area of the first portion, and the at least one second apertures cover/extend over approximately half of the circumference or surface area of the second portion.

Optionally, the first heat exchanger arrangement is generally annular, and the second flow path is arranged to extend generally parallel to a longitudinal axis of the engine through the centre of the generally annular first heat exchanger arrangement.

Optionally, the first heat exchanger arrangement comprises a generally cylindrical annular heat exchanger or a generally conical annular heat exchanger through which air is configured to flow from the first heat exchanger inlet to the first heat exchanger outlet in a generally radial direction that is perpendicular to the longitudinal axis of the engine.

Optionally, the first heat exchanger arrangement comprises a plate heat exchanger.

Optionally, the first heat exchanger arrangement comprises a plurality of tubes for the flow of a heat transfer medium in heat exchange with the air received by the first heat exchanger inlet, wherein the first flow path is arranged to extend around and/or between said tubes.

Optionally, the first heat exchanger arrangement comprises a plurality of heat exchanger modules, the plurality of heat exchanger modules being arranged to be generally centred on and arranged along a longitudinal axis of the engine. Optionally, the modules are generally annular. Optionally, at least one of the plurality of heat exchanger modules is arranged to overlap with at least one other one of the plurality of heat exchanger modules relative to the longitudinal axis of the engine. The plurality of heat exchanger modules may be arranged to be in fluid communication with one another. The plurality of heat exchanger modules may be arranged in series and/or in parallel relative to the longitudinal axis of the engine.

Optionally, each of the plurality of heat exchanger modules may comprise a plurality of tubes for the flow of a heat transfer medium in heat exchange with the air received by the first heat exchanger inlet. The first heat exchanger arrangement may be configured such that air is configured to flow around and/or between the plurality of tubes as it flows through the first heat exchanger arrangement. The plurality of tubes may be arranged to be each wound in a respective path that gradually widens or tightens about the longitudinal axis of the engine and each spaced apart from one another in rows along the longitudinal axis of the engine. For example, the plurality of tubes may be arranged in involute spiral paths, which may extend circumferentially about the longitudinal axis of the engine.

Advantageously, the modular structure of the first heat exchanger arrangement provides that the engine may be configured such that the flow of a heat transfer medium in one or more of the heat exchanger modules may be modulated or completely turned off separately (i.e. independently from the flow of a heat transfer medium in the other heat exchanger modules). Additionally, the heat exchanger modules of the engine may provide that a proportion of the air may pass through each heat exchanger module and be cooled by a heat transfer medium in the first heat exchanger arrangement. Advantageously, this may further provide for improved optimisation, flexibility and control of the temperature profile of the air flowing through the engine.

Optionally, at least a portion of the first flow path is arranged between the flow control arrangement and an outer housing of the engine.

Optionally, the flow control arrangement comprises at least a portion that is generally in the shape of a cone or a truncated cone and/or an axisymmetric curved shape.

Advantageously, such a flow control arrangement may be configured to slow down the flow of incoming air received by the air inlet, for example to slow it from a supersonic flight speed to a subsonic flight speed.

Optionally, the engine further comprises an actuator arrangement for actuating the flow control arrangement, to cause the first and second portion to move relative to one another to selectively obstruct and un-obstruct the second flow path.

Optionally, the actuator arrangement comprises one or more active actuators such as one or more fueldraulic, hydraulic, pneumatic, ball-screw and/or electric actuators and/or one or more passive actuators. Optionally, the actuator arrangement may be configured to be passively actuated by utilising the variation between at least two different local air pressures in the engine.

Optionally, the flow control arrangement comprises one or more inconel nickel alloys and/or ceramic composites, to advantageously improve the maximum operating temperature of the flow control arrangement.

Optionally, the engine may further comprise a plurality of turning vanes configured to direct the flow of air into and out of the first heat exchanger arrangement. Advantageously, this may provide for the air flow to be directed into and out of the first heat exchanger arrangement. Said plurality of turning vanes may be configured to turn the air flow through an angle of approximately 90 degrees, to guide the air flow from generally along a longitudinal axis of the engine to generally along a radial direction of the engine, or vice versa.

Optionally, the engine may further comprise a separator duct arranged on the outside of the first heat exchanger arrangement. Advantageously, the separator duct may prevent debris and large particles that may be ingested into the air inlet from impacting on the heat exchanger arrangement.

Optionally, the engine further comprises: a second heat exchanger arrangement arranged upstream of the first heat exchanger arrangement, having a second heat exchanger inlet configured to receive at least a portion of the air received by the air inlet, and being configured to cool the air received by the second heat exchanger inlet; and a third flow path arranged to extend from the air inlet to the second heat exchanger inlet; wherein the at least one inlet flow aperture is positioned between the first and second heat exchanger arrangements.

Advantageously, such an engine can provide that when operating at relatively low flight speeds, for example at or below approximately Mach 1.5, a first portion of the air entering the engine via the air inlet is caused to flow along the first flow path such that it is caused to be precooled in the first heat exchanger arrangement, a second portion of air is caused to flow 35 along the third flow path such that it is caused to be precooled in the second heat exchanger arrangement, and a third portion of air is caused to flow along the second flow path such that it bypasses the first heat exchanger arrangement. This is advantageous because at relatively low flight speeds, full precooling of all of the air entering the engine via the air inlet is not needed, so it would be more efficient to precool only a portion of the air, leaving some of the air (i.e. that which flows along the second flow path) uncooled, to advantageously reduce the total inlet pressure loss at such lower flight speeds, resulting in a more efficient engine. Together, the first and second heat exchanger arrangements may be referred to as constituting a “modular heat exchanger arrangement”, and such an engine thus advantageously provides for selective bypassing of one or more modules in a modular heat exchanger arrangement by providing for selective bypassing/circumvention of one or more modules. Such an engine may thus advantageously be employed in high Mach/hypersonic platforms with improved efficiency, by reducing pressure losses and increasing the pressure recovery factor (PRF). Furthermore, since the at least one inlet flow aperture is positioned between the first and second heat exchanger arrangements, and the second flow path is arranged to bypass the first heat exchanger arrangement (which is arranged downstream of the second heat exchanger arrangement), the location of the at least one inlet flow aperture advantageously allows the air flow to settle upstream of the one or more turbomachinery components whilst also allowing for the possibility of access for a diagonal rocket thrust strut to pass through to the wingtip.

Optionally, the first and second heat exchanger arrangements are arranged to be spaced apart from one another along a longitudinal axis of the engine.

Optionally, the flow control arrangement comprises at least one butterfly valve. Optionally, said first portion of the flow control arrangement comprises a respective disc of each of the at least one butterfly valves configured to rotate within and relative to said second portion of the flow control arrangement, to selectively obstruct the second flow path, the second portion comprising an outer structure of each of the at least one butterfly valves.

Advantageously, butterfly valves are lightweight and may be less prone to jamming under mechanical distortion of the first and/or second heat exchanger arrangements.

Optionally, the flow control arrangement comprises a plurality of butterfly valves angularly spaced apart from one another relative to a longitudinal axis of the engine.

Optionally, the plurality of butterfly valves comprises a first set of butterfly valves configured to be rotated in a first direction and a second set of butterfly valves configured to be rotated in a second direction that is opposite to the first direction, wherein the first and second sets of butterfly valves are arranged alternately with respect to one another about the longitudinal axis of the engine.

Advantageously, rotating alternate butterfly valves in opposite directions can eliminate outlet swirl.

Optionally, the first and second heat exchanger arrangements are generally annular and are arranged along and generally centred on a longitudinal axis of the engine, and are each configured for air to flow therethrough in a generally radial direction that is perpendicular to a longitudinal axis of the engine, and the plurality of butterfly valves are arranged adjacent a bore of the first and/or second heat exchanger arrangements.

Optionally, the engine further comprises a generally cylindrical perforated drum configured to support the first and second heat exchanger arrangements, the flow control arrangement being attached to said drum.

Optionally, the first and second heat exchanger arrangements are generally annular and are arranged within an outer housing of the engine; a first portion of the second flow path is arranged to extend generally parallel to the longitudinal axis of the engine between the outer housing and the second heat exchanger arrangement; a second portion of the second flow path is arranged to extend generally perpendicular to said longitudinal axis in said gap between the first and second heat exchanger arrangements; and a third portion of the second flow path is arranged to extend generally parallel to said longitudinal axis through the centre of the generally annular first heat exchanger arrangement.

Optionally, the first heat exchanger arrangement is configured to be supplied with a heat transfer medium for undergoing heat transfer with the air received by the first heat exchanger inlet. The heat transfer medium may be any fuel type, any gas, any liquid, and/or any cryogenic fluid, for example, the heat transfer medium may be helium, kerosene, ammonia or hydrogen. The heat transfer medium may comprise a fuel, or the heat transfer medium may comprise a fluid that is different to and separate to (i.e. fluidly isolated from) a fuel used in the engine. The heat transfer medium may comprise a fluid that is different to and separate to (i.e. fluidly isolated from) a fuel used in the engine, and the engine may further comprise a third heat exchanger arrangement configured to provide for heat transfer between said heat transfer medium and said fuel. The fuel may comprise hydrogen. The fuel may be provided in liquid form or cryogenic form, for example, the fuel may comprise liquid hydrogen.

Optionally, the first heat exchanger arrangement may be configured such that air is configured to flow into and through the first heat exchanger arrangement substantially along the radial direction of the engine, i.e. to flow substantially perpendicular to the longitudinal axis of the engine.

According to a second aspect of the disclosure, there is provided a method of operating an engine according to the first aspect of the disclosure, the method comprising: causing air to flow along the first flow path such that at least a portion of the air received by the air inlet is cooled in the first heat exchanger arrangement by undergoing heat exchange with a heat transfer medium configured to flow through the first heat exchanger arrangement, before flowing downstream to the one or more turbomachinery components;
providing at least one actuating means for moving the first and second portions of the flow control arrangement relative to one another; and using the at least one actuating means to move the first and second portions relative to one another to un-obstruct the second flow path, such that at least a portion of the air received by the air inlet is caused to flow along the second flow path, thus bypassing the first heat exchanger inlet.

Optionally, the heat transfer medium is helium, kerosene, ammonia or hydrogen.

According to a third aspect of the disclosure, there is provided an engine, comprising: an air inlet configured to receive air; a first compressor configured to receive air; a first heat exchanger arrangement configured to cool air; the first compressor and the first heat exchanger arrangement being arranged downstream of the air inlet and being arranged along and generally centred on a longitudinal axis of the engine, and the first compressor having a radial direction that is perpendicular to said longitudinal axis; a first flow path arranged to extend through the first heat exchanger arrangement and an inner radial portion of the first compressor; and a second flow path arranged to extend through an outer radial portion of the first compressor, the second flow path bypassing the first heat exchanger arrangement.

Advantageously, such an engine can provide that air flowing through/around the inner radial portion of the compressor may be cooled more than air flowing through/around the outer radial portion of the compressor. Accordingly, such an engine can provide that all of the heat and temperature reduction capability of the first heat exchanger arrangement can be applied to/directed to only cool the air which really needs to be cooled, without doing any superfluous cooling, thus resulting in reduced pressure losses and hence improved overall engine efficiency. Furthermore, by providing enhanced cooling of the air which is configured to flow through the inner radial portion of the first compressor, leaving the air flowing through the outer radial portion of the first compressor either relatively uncooled or cooled to a lesser degree, this provides significant stress related to the first compressor, and especially to roots of its blades. This is because in general, keeping the inner radial portion and hence roots of said blades (i.e. a “hub section” of the first compressor) cool will provide a significant advantage to the engine's turbomachinery, because the inefficiency of the first compressor would otherwise typically manifest itself in flows along an inner wall of the first compressor as high temperature with lower pressure, this central area of the first compressor being where the rotating parasitic mass of the first compressor's blades meet a supporting/heavy thermally unresponsive disc/shaft of the first compressor. Thus, since the first compressor is configured to operate across both the first and second flow paths, such an engine advantageously provides an opportunity for the lower engine core air temperature to cool the first compressor itself, despite the outer radial portion thereof being in a relatively high temperature air flow. Thus, advantageously, blades of the first compressor may conduct heat away from relatively hotter blade tips towards relatively cooler but more highly mechanically stressed blade roots (i.e. from the radial outer portion to the radial inner portion). Advantageously, the highly stressed radial inner portion, which typically carries all the parasitic stress of the blades may thus be running at a significantly cooler temperature. In turn, this may advantageously reduce the inlet temperature of a second compressor in the engine, thus allowing said second compressor to generate an increased pressure ratio and flow, thus increasing the engine's overall specific thrust significantly more than if all of the air flow entering the engine via the air inlet were to be cooled in the first heat exchanger arrangement. Furthermore, this will also serve to better protect any bearing chambers, rotating machinery discs and seals etc. in the engine. In addition, when the engine is a bypass engine (i.e. an engine having a non-zero bypass ratio), this can enable the precooling action of the first heat exchanger arrangement to be directed more efficiently at the part of the engine's operating cycle that is causing specific thrust reduction/limitation, as the operational/flight speed of the engine increases, thus resulting in improved engine efficiency.

Optionally, the engine further comprises one or more turbomachinery components configured to receive air and arranged downstream of the first compressor, and one or more exhaust nozzles arranged downstream of the one or more turbomachinery components; wherein the first and second flow paths are arranged to extend from the air inlet to the one or more exhaust nozzles.

Optionally, the first flow path is arranged to extend through the one or more turbomachinery components, and the second flow path is arranged to bypass the one or more turbomachinery components. In other words, the engine may be a bypass engine, i.e. an engine having a bypass ratio (“BPR”), which is the ratio of the mass flow rate of the second flow path to the mass flow rate of the first flow path, that is greater than zero. Advantageously, such an engine can offer an improved level of specific thrust whilst also offering a moderate specific fuel consumption. Optionally, the bypass ratio is between 0.5 and 1.

Optionally, the engine further comprises a generally cylindrical outer casing within which the first compressor and the first heat exchanger arrangement are arranged. Optionally, the engine further comprises a generally cylindrical inner casing arranged concentrically inside the outer casing and within which the first heat exchanger arrangement is arranged. Optionally, at least a portion of the first flow path is arranged to extend through the centre of the generally cylindrical inner casing, and at least a portion of the second flow path is arranged to extend between the inner and outer casings.

Optionally, the first compressor comprises a plurality of blades angularly spaced apart from one another and each arranged to extend generally along said radial direction, wherein each of the blades has a root and a tip, the root being arranged closer to said longitudinal axis than the tip, such that at least a portion of the first flow path is arranged to extend adjacent the roots of the blades, and at least a portion of the second flow path is arranged to extend adjacent the tips of the blades.

Optionally, the first heat exchanger arrangement is arranged upstream of the first compressor.

Optionally, the first heat exchanger arrangement is arranged downstream of the first compressor and upstream of the one or more turbomachinery components.

Optionally, the engine further comprises a second heat exchanger arrangement configured to cool air arranged downstream of the air inlet and being arranged along and generally centred on said longitudinal axis; wherein the second flow path is arranged to extend through the second heat exchanger arrangement; such that the first heat exchanger arrangement is configured to cool a first portion of air received by the air inlet, and the second heat exchanger arrangement is configured to cool a second portion of air received by the air inlet, the first portion of air being configured to flow along the first flow path, and the second portion of air being configured to flow along the second flow path. The second heat exchanger arrangement may be arranged upstream of the first compressor. The second heat exchanger arrangement may be arranged downstream of the first compressor and upstream of the one or more turbomachinery components.

Advantageously, such an engine may provide that substantially all of the air entering the engine via the air inlet is cooled, but that the air flowing along the first flow path through the inner radial portion of the first compressor may be selectively cooled to a greater extent than the air flowing along the second flow path through the outer radial portion of the first compressor. The amount of a heat transfer medium flowing through the second heat exchanger arrangement may be controlled to be selectively reduced relative to the amount of a heat transfer medium flowing through the first heat exchanger arrangement, and/or stopped entirely, to selectively reduce the cooling capacity/effect of the second heat exchanger arrangement compared with that of the first heat exchanger arrangement. This may be done at high flight speeds/low operational speeds of the engine, for example at above approximately Mach 1.5, and/or in different modes of operation of the engine, to reduce or entirely stop the amount of precooling being performed on the air flowing along the second flow path, or to entirely stop the air flowing along the second flow path from being precooled.

Optionally, the engine further comprises a flow control arrangement configured to selectively control the amount of a heat transfer medium flowing through the second heat exchanger arrangement for undergoing heat transfer with said second portion of the air.

Advantageously, such an engine may provide for the cooling action of the second heat exchanger arrangement to be reduced relative to the cooling action of the first heat exchanger arrangement, or stopped entirely, to reduce or entirely stop the amount of precooling being performed on the air flowing along the second flow path, to advantageously focus the cooling on the inner radial portion of the first compressor, resulting in thermodynamic and mechanical advantages as discussed above, and thus leading to improved engine efficiency.

Optionally, the one or more turbomachinery components comprises a second compressor, at least one combustion chamber, and at least one turbine, the second compressor being configured to operate at a higher air pressure than the first compressor.

Optionally, the first heat exchanger arrangement is arranged upstream of the second compressor.

Optionally, the at least one combustion chamber comprises an air-breathing combustion chamber configured to receive compressed air from the second compressor and for the combustion of air and fuel, and a rocket combustion chamber for the combustion of fuel and oxidant, wherein the air-breathing combustion chamber and the rocket combustion chamber are configured to be operated independently.

Optionally, the engine further comprises a ramjet.

According to a fourth aspect of the disclosure, there is provided a method of operating an engine according to the third aspect of the disclosure, the method comprising: causing air to flow along the first flow path such that at least a first portion of the air received by the air inlet is configured to flow adjacent the inner radial portion of the first compressor and is cooled in the first heat exchanger arrangement by undergoing heat transfer with a heat transfer medium configured to flow through the first heat exchanger arrangement; and causing air to flow along the second flow path such that at least a second portion of the air received by the air inlet is configured to flow adjacent the outer radial portion of the first compressor and to bypass the first heat exchanger.

Optionally, the heat transfer medium is helium, kerosene, ammonia or hydrogen.

According to a fifth aspect of the disclosure, there is provided an engine, comprising: an air inlet configured to receive air; a first heat exchanger arrangement arranged downstream of the air inlet and configured to cool at least a portion of the air received by the air inlet; a first compressor arranged downstream of the first heat exchanger arrangement and configured to receive and compress at least a portion of the air cooled by the first heat exchanger arrangement; a second heat exchanger arrangement arranged downstream of the first compressor and configured to cool at least a portion of the air compressed by the first compressor; and a second compressor arranged downstream of the second heat exchanger arrangement and configured to receive and compress at least a portion of the air cooled by the second heat exchanger arrangement, the second compressor being configured to operate at a higher air pressure than the first compressor.

Such an engine can provide that substantially all of the air flow entering the engine via the air inlet is configured to be precooled by the first heat exchanger arrangement, and then to be intercooled by the second heat exchanger arrangement between the two compression stages in the first and second compressors. Advantageously, intercooling the air flow in the second heat exchanger allows for the second high pressure compressor to produce more work, by removing the waste heat from the first compression stage performed by the first low pressure compressor. Advantageously, performing both intercooling and precooling on the air flow (i.e. cooling the air both before and after the first compression stage in the first compressor) provides for reduced pressure losses, improved flexibility in operating the engine at different speeds, and improved overall engine efficiency.

Optionally, the first and second heat exchanger arrangements and the first and second compressors are arranged along and generally centred on a longitudinal axis of the engine, and the first and second heat exchanger arrangements are both generally annular and are configured for air to flow therethrough in a generally radial direction that is perpendicular to said longitudinal axis of the engine.

Optionally, the first and/or second heat exchanger arrangements each comprises a plurality of heat exchanger modules arranged along said longitudinal axis of the engine.

According to a sixth aspect of the disclosure, there is provided a method of operating an engine according to the fifth aspect of the disclosure, the method comprising: causing air to enter the engine via the air inlet;
cooling at least a portion of the air received by the air inlet in the first heat exchanger arrangement using a first heat transfer medium; compressing at least a portion of the air cooled by the first heat exchanger arrangement in the first compressor; cooling at least a portion of the air compressed by the first compressor in the second heat exchanger arrangement using a second heat transfer medium; and compressing at least a portion of the air cooled by the second heat exchanger arrangement in the second compressor.

Optionally, the first heat transfer medium and/or the second heat transfer medium comprises helium, kerosene, ammonia or hydrogen.

According to a seventh aspect of the disclosure, there is provided an engine, comprising: an air inlet configured to receive air; a heat exchanger arrangement arranged downstream of the air inlet, the heat exchanger arrangement configured for the flow of a heat transfer medium therethrough to cool air; one or more turbomachinery components arranged downstream of the heat exchanger arrangement and configured to receive air; a first flow path for the flow of air through the engine, arranged to extend from the air inlet to the one or more turbomachinery components via an inlet and an outlet of the heat exchanger arrangement; and an injection arrangement arranged downstream of the air inlet and comprising at least one injector nozzle configured to inject a liquid coolant into the first flow path upstream of the one or more turbomachinery components.

Advantageously, injecting droplets of a liquid coolant into the first flow path upstream of the one or more turbomachinery components can provide for improved cooling of the air, by supplementing/enhancing the cooling action of the heat exchanger arrangement. In particular, droplets of the liquid coolant in the first flow path will absorb heat from air flowing along the first flow path and will thus evaporate, in doing so, cooling the air. In other words, the vaporisation of the droplets will cause a reduction in the air temperature. This is in addition to the cooling of the air that is achieved by placing said air into heat transfer with a heat transfer medium in the heat exchanger arrangement. This combination is particularly advantageous because if the injection arrangement were to be used on its own to cool the air without the heat exchanger also being present in the engine, then the mass of liquid coolant required to provide for sufficient air cooling would be significantly large, and this large mass could potentially negate the benefits of any such cooling, since in aerospace applications for example, it is highly desirable to minimise mass to achieve improved efficiency and reduce fuel consumption. Also, when using coolant injection alone to cool air, there may be difficulties in ensuring that all of the coolant evaporates in time before the air flow enters the one or more turbomachinery components. By combining the injection arrangement with the heat exchanger arrangement, advantageously the injection arrangement can thus aid the cooling action of the heat exchanger arrangement, and vice versa, to provide that at least a portion of the air flowing along the first flow path is cooled as much as possible prior to ingestion in the one or more turbomachinery components. Advantageously, since the heat exchanger is also being used to perform some of said cooling, a lower mass of coolant is required for the injection arrangement.

Also, the injection arrangement can be used effectively to reduce the peak heat transfer requirement of the heat exchanger arrangement by “peak-load loping”, thus enabling the heat exchanger arrangement to be sized for more moderate heat transfer rates rather than for the peak heat transfer rate, thus reducing the size (and hence also the mass) of the heat exchanger and the engine. Furthermore, the combined use of the injection arrangement with the heat exchanger arrangement also enables operational flexibility of the engine, potentially allowing for high vehicle speeds to be accessed for short periods of time, when the engine is applied in a vehicle, for example an aerospace vehicle.

Optionally, the coolant comprises water and/or methanol.

Optionally, the coolant consists of water.

Advantageously based on its latent heat of vaporisation and specific heat capacity, using water as the coolant may provide for optimum cooling of the air to better aid the cooling operation of the heat exchanger arrangement.

Optionally, the injection arrangement is configured to inject the liquid coolant into the first flow path upstream of the heat exchanger outlet.

Advantageously, this can provide that droplets of the liquid coolant have more time to evaporate before the air flow is ingested into the one or more turbomachinery components.

Optionally, the injection arrangement is configured to inject the liquid coolant into the first flow path upstream of the heat exchanger inlet.

It is desirable for the liquid coolant droplets to evaporate by the time that the flow along the first flow path reaches the one or more turbomachinery components. Injecting the liquid coolant into the first flow path upstream of the heat exchanger inlet is thus advantageous because the flow of air through the heat exchanger arrangement will generally be slower than the flow of air into the engine via the air inlet, meaning that more time is available for the droplets to evaporate.

Optionally, the heat exchanger arrangement comprises a plurality of tubes for the flow of the heat transfer medium therethrough, wherein the first flow path is arranged to extend around and/or between said tubes.

Advantageously, when droplets of the liquid coolant are caused to flow from the heat exchanger inlet to the heat exchanger outlet, they can strike the tubes, through inertial effects, causing the droplets to break up and further slowing them down, thus encouraging and increasing the rate of their evaporation.

Optionally, the heat exchanger arrangement and the injection arrangement are both generally annular and are arranged along and generally centred on a longitudinal axis of the engine; at least a portion of the heat exchanger arrangement is arranged concentrically inside at least a portion of the injection arrangement; and the injection arrangement comprises a plurality of injector nozzles angularly spaced apart from one another relative to said longitudinal axis.

Optionally, a portion of the heat exchanger arrangement is arranged concentrically inside at least a portion of the injection arrangement.

Optionally, the at least one injector nozzle is configured to inject the liquid coolant into a portion of the first flow path, such that only a portion of the air configured to flow along the first flow path is configured to be cooled by the liquid coolant.

Optionally, when the engine is in operation, a first portion of air is configured to flow along the first flow path, and a second portion of air is configured to flow along the first flow path, the at least one injector nozzle being configured to inject the liquid coolant into one of the first or second portions, such that the other one of the first or second portions of air is not configured to be cooled by the liquid coolant.

Optionally, the injection arrangement comprises at least one first injector nozzle and at least one second injector nozzle arranged downstream of the at least one first injector nozzle.

Optionally, the injection arrangement further comprises one or more actuators configured to actuate the at least one first injector nozzle and the at least one second injector nozzle independently of one another.

Advantageously, this can provide that only a portion of the air being cooled by the heat exchanger arrangement is further cooled by the injection arrangement, e.g. such that a first portion of air being cooled by the heat transfer medium in the heat exchanger arrangement is configured to be further cooled by the injection arrangement, whilst a second portion of air being cooled by the heat transfer medium in the heat exchanger arrangement is configured to not be further cooled by the injection arrangement. For example, a first injector nozzle may be actuated independently of a second injector nozzle to provide for selective cooling in one or more regions/portions of air flow. Advantageously, this can provide that only a portion of the air is further cooled, by applying the injection arrangement to only some of the air flow entering the engine. This is advantageous because for example, at a low flight speed that is between subsonic to approximately Mach 1.5, full cooling of all of the air flow is not needed, and it would be more efficient to further cool using the liquid coolant/injection arrangement only a portion of the air, to advantageously reduce the total inlet pressure loss at such lower flight speeds, resulting in a more efficient engine. Furthermore, the injection arrangement in such an arrangement would therefore be of reduced mass and size and would require a reduced mass of water, thus resulting in improved engine efficiency.

Optionally, the injection arrangement comprises at least one first injector nozzle and at least one second injector nozzle arranged downstream of the at least one first injector nozzle; the at least one first injector nozzle is configured to inject first droplets of the liquid coolant into the first flow path; and the at least one second injector nozzle is configured to inject second droplets of the liquid coolant into the first flow path that have a smaller size than and/or at a lower mass flow rate than the first droplets.

Advantageously, the first droplets are injected further upstream than the second droplets so they have more time to evaporate, to increase the chances of them evaporating by the time the flow reaches the one or more turbomachinery components, and to increase their cooling capability of the air. The smaller and/or slower second droplets are injected further downstream, so that their initial size and/or speed is smaller to increase the chances of them evaporating by the time the flow reaches the one or more turbomachinery components, since they have a shorter distance to travel. Since the first droplets have a larger size and/or higher mass flow rate, they can provide for more cooling than the second droplets, and arranging them upstream of the second droplets provides that as well as providing for more cooling, they will also evaporate in time.

Optionally, the injection arrangement further comprises one or more actuators configured to actuate the at least one first injector nozzle and the at least one second injector nozzle independently of one another.

Optionally, the at least one injector nozzle is further configured to inject an antifreeze into the first flow path.

Advantageously, this may prevent frost formation in and/or on the heat exchanger arrangement.

Optionally, the antifreeze may comprise methanol.

Optionally, the injection arrangement further comprises one or more valves arranged upstream of the at least one injector nozzle and configured to open and close to control the flow of the liquid coolant through the at least one injector nozzle.

Optionally, the injection arrangement further comprises one or more actuators configured to actuate the opening and closing of the one or more valves.

Optionally, the injection arrangement further comprises a coolant supply for supplying the liquid coolant to the at least one injector nozzle. Optionally, the injection arrangement further comprises one or more valves configured to control the supply of the liquid coolant to the at least one injector nozzle from the coolant supply. Optionally, the one or more valves are controlled by one or more actuators, for example an electric pump. Optionally, each of the at least one injector nozzles is associated with its own respective actuator, such that the flow of the liquid coolant through each of the at least one injector nozzle may be controlled (e.g. “turned off” or “turned on”) through each of the respective individual injector nozzles.

According to an eighth aspect of the disclosure, there is provided a method of operating an engine according to the seventh aspect of the disclosure, the method comprising: causing air to flow along the first flow path such that at least a portion of the air received by the air inlet is cooled in the heat exchanger arrangement by undergoing heat exchange with the heat transfer medium, before flowing downstream to the one or more turbomachinery components; and injecting the liquid coolant into the first flow path to supplement the cooling action of the heat transfer medium in the heat exchanger arrangement, to further cool at least a portion of said at least a portion of the air received by the air inlet before it flows downstream to the one or more turbomachinery components.

Optionally, the liquid coolant consists of water.

Optionally, the method further comprises actuating one or more valves arranged upstream of the at least one injector nozzle to control the flow of the liquid coolant through the at least one injector nozzle.

According to a ninth aspect of the disclosure, there is provided an engine, comprising: an air inlet configured to receive air; a heat exchanger arrangement configured downstream of the air inlet, the heat exchanger arrangement configured to cool at least a portion of the air received by the air inlet; one or more turbomachinery components arranged downstream of the heat exchanger arrangement and configured to receive air; and a throttling arrangement arranged upstream of the one or more turbomachinery components and configured to control the mass flow rate of air flow through the heat exchanger arrangement.

Advantageously, this can allow the one or more turbomachinery components (which may be referred to as a “core engine” or “engine core”) to effectively operate at a lower pressure than the air intake arrangement. Also, when employed in a bypass engine (i.e. an engine having a non-zero BPR), this can allow the core engine to effectively operate at a lower pressure than the bypass system, thus permitting the bypass pressure to be increased to up to 1.9 bar, thereby increasing the bypass thrust at high Mach numbers whilst maintaining the non-dimensional operating point of a compressor in the engine constantly to modulate the flow therethrough, to achieve higher thrust at high Mach numbers/high flight speeds. The throttling arrangement also advantageously permits deep throttling of the airbreathing engine at fixed non-dimensional conditions which could be useful for engine starting, ferry flights and aborts.

Optionally, the throttling arrangement is arranged upstream of an outlet of the heat exchanger arrangement.

Optionally, the throttling arrangement is arranged upstream of an inlet of the heat exchanger arrangement.

Optionally, the throttling arrangement comprises one or more valves each configured to be movable into an open position, a closed position, and at least one intermediate position therebetween, to control the flow of air therethrough.

Advantageously, the throttling arrangement may be used to throttle the flow of air through the heat exchanger arrangement. That is, unless all of the one or more valves are completely closed, substantially all of the air received in the engine by the air inlet will be caused to flow into an inlet of the heat exchanger arrangement, such that substantially all of the air received into the engine is cooled by the heat exchanger arrangement, but by varying the size of the opening through each of the one or more valves by moving them between the open and closed positions thereof, the mass flow rate of the air therethrough, and hence the mass flow rate of air through the heat exchanger arrangement, can be reduced/controlled. This can be done to reduce the pressure mismatch in the engine to balance the pressure across the heat exchanger arrangement.

Optionally, the one or more valves comprises a plurality of butterfly valves angularly spaced apart from one another relative to a longitudinal axis of the engine.

Optionally, the plurality of butterfly valves are arranged to be angularly spaced apart from one another relative to a longitudinal axis of the engine in rows spaced apart from one another along said longitudinal axis.

Optionally, the plurality of butterfly valves comprises a first set of butterfly valves configured to be rotated in a first direction and a second set of butterfly valves configured to be rotated in a second direction that is opposite to the first direction, wherein the first and second sets of butterfly valves are arranged alternately with respect to one another about the longitudinal axis of the engine.

Advantageously, rotating alternate butterfly valves in opposite directions can eliminate outlet swirl.

Optionally, the throttling arrangement further comprises one or more actuators configured to actuate the movement of the one or more valves.

Optionally, the heat exchanger arrangement comprises a generally annular cylindrical heat exchanger. Optionally, the heat exchanger arrangement comprises a generally annular conical heat exchanger. Optionally, the heat exchanger arrangement comprises a plate heat exchanger. Optionally, the heat exchanger arrangement comprises a plurality of heat exchanger modules.

Optionally, the heat exchanger arrangement is generally annular and is arranged along and generally centred on a longitudinal axis of the engine, and is configured for air to flow therethrough in a generally radial direction that is perpendicular to said longitudinal axis; and the throttling arrangement is arranged on or adjacent a bore of the generally annular heat exchanger arrangement.

Optionally, the heat exchanger arrangement comprises: at least one fluid conduit section for the flow of a heat transfer medium therethrough, wherein said at least a portion of the air received by the air inlet is configured to flow around and/or between said at least one fluid conduit section; and a support structure comprising a generally cylindrical perforated drum structure, to which the throttling arrangement is attached.

Optionally, the heat exchanger arrangement comprises a plurality of heat exchanger modules; and the throttling arrangement comprises a plurality of groups of valves each associated with one of the heat exchanger modules, wherein each of the groups of valves is configured to be actuated independently with respect to the other groups of valves, to independently control the mass flow rate of air flow through its respective heat exchanger module.

Advantageously, this can enable the precooling action of the heat exchanger arrangement to be directed more efficiently at the part of the engine's operating cycle that is causing specific thrust reduction/limitation, as the operational speed of the engine increases, to reduce pressure losses by avoiding superfluously cooling any air that does not need to be cooled, thus resulting in improved engine efficiency.

According to a tenth aspect of the disclosure, there is provided a method of operating an engine according to the ninth aspect of the disclosure, the method comprising: causing air to enter the engine via the air inlet; causing at least a portion of the air received by the air inlet to flow downstream to be cooled in the heat exchanger arrangement by a heat transfer medium; and actuating the throttling arrangement to control the mass flow rate of air flow through the heat exchanger arrangement.

It is to be understood that an engine according to the first aspect of the disclosure may be combined with one or more of the above features of the engines according to the third, fifth, seventh and/or ninth aspects of the disclosure, though said features are not repeated herein, for the sake of conciseness and to avoid repetition.

Similarly, it is to be understood that an engine according to the third aspect of the disclosure may be combined with one or more of the above features of the engines according to the first, fifth, seventh and/or ninth aspects of the disclosure.

It is to be understood that an engine according to the fifth aspect of the disclosure may be combined with one or more of the above features of the engines according to the first, third, seventh and/or ninth aspects of the disclosure.

It is to be understood that an engine according to the seventh aspect of the disclosure may be combined with one or more of the above features of the engines according to the first, third, fifth and/or ninth aspects of the disclosure.

It is to be understood that an engine according to the ninth aspect of the disclosure may be combined with one or more of the above features of the engines according to the first, third, fifth and/or seventh aspects of the disclosure.

According to an eleventh aspect of the disclosure, there is provided an aircraft, flying machine or aerospace vehicle comprising an engine according to any one or more of the first, third, fifth, seventh and/or ninth aspects of the disclosure.

### BRIEF DESCRIPTION OF THE DRAWINGS

The present disclosure may be carried out in various ways and embodiments of the disclosure will now be described by way of example with reference to the accompanying drawings, in which:

FIG. 1 (prior art) shows a cross-sectional schematic view of a precooled engine;

FIG. 2 (prior art) shows an alternative cross-sectional schematic view of a precooled engine;

FIG. 3 shows a cross-sectional schematic view of a precooled engine having a flow control arrangement;

FIG. 4 shows a cross-sectional schematic view of the engine shown in FIG. 3;

FIG. 5 shows a cross-sectional schematic view of the engine shown in FIG. 3, with the flow control arrangement shown in a closed position;

FIG. 6 shows a cross-sectional schematic view of the engine shown in FIG. 3, with the flow control arrangement shown in an open position;

FIG. 7 shows a cross-sectional schematic view of a precooled engine having a flow control arrangement;

FIG. 8 shows a cross-sectional schematic view of a precooled engine having a flow control arrangement;

FIG. 9 shows a cross-sectional schematic view of a precooled engine having a flow control arrangement, with the flow control arrangement shown in an open position;

FIG. 10 shows a cross-sectional schematic view of the engine shown in FIG. 9, with the flow control arrangement shown in a closed position;

FIG. 11 shows a front-perspective view of the flow control arrangement of the engine shown in FIGS. 9 and 10;

FIG. 12 shows a front perspective view of a precooled engine having a flow control arrangement;

FIG. 13 shows a rear perspective view of the flow control arrangement of the engine shown in FIG. 12;

FIG. 14 shows a cross-sectional view of the flow control arrangement shown in FIG. 13, with the flow control arrangement shown in a closed position;

FIG. 15 shows a cross-sectional view of the flow control arrangement shown in FIG. 13, with the flow control arrangement shown in an open position;

FIG. 16 shows a cross-sectional schematic view of a heat exchanger arrangement having a flow control arrangement and a throttling arrangement;

FIG. 17 shows a cross-sectional schematic view of an engine having a heat exchanger with a flow control arrangement as shown in FIG. 16, with the flow control arrangement shown in a closed position;

FIG. 18 shows a cross-sectional schematic view of the engine shown in FIG. 17, with the flow control arrangement shown in an open position;

FIG. 19 shows a butterfly valve in a closed position;

FIG. 20 shows a butterfly valve in an intermediate position;

FIG. 21 shows a butterfly valve in an open position;

FIG. 22 shows a cross-sectional schematic view of an engine having a partial inlet air flow cooling arrangement;

FIG. 23 shows a cross-sectional schematic view of a compressor;

FIG. 24 shows a cross-sectional schematic view of an engine having a partial inlet air flow cooling arrangement;

FIG. 25 shows a cross-sectional schematic view of an engine having a partial inlet air flow cooling arrangement;

FIG. 26 shows a cross-sectional schematic view of an engine having a partial inlet air flow cooling arrangement;

FIG. 27 shows a cross-sectional schematic view of an engine having a partial inlet air flow cooling arrangement;

FIG. 28 shows a cross-sectional schematic view of an engine having a partial inlet air flow cooling arrangement;

FIG. 29 shows a cross-sectional schematic view of an engine having a precooling and intercooling cooling arrangement;

FIG. 30 shows a cross-sectional schematic view of an engine having an injection cooling arrangement;

FIG. 31 shows a front perspective view of the injection cooling arrangement of the engine shown in FIG. 30;

FIG. 32 shows a cross-sectional schematic view of an injection cooling arrangement and a heat exchanger arrangement of an engine;

FIG. 33 shows a cross-sectional schematic view of an injection cooling arrangement and a heat exchanger arrangement of an engine; and

FIG. 34 shows a cross-sectional schematic view of a heat exchanger arrangement and a throttling arrangement of an engine.

### DETAILED DESCRIPTION

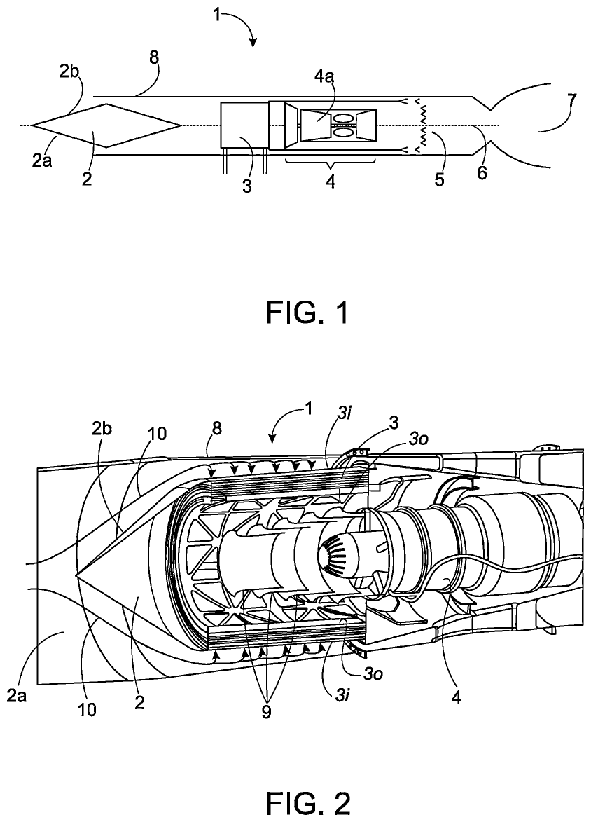

FIG. 1 (prior art) shows a cross-sectional schematic view of a precooled turbomachinery based engine 1 having a supersonic/hypersonic air intake arrangement 2. Air is configured to enter the engine 1 at an air inlet 2a of the air intake arrangement 2 and then to flow around the air intake cone 2b, which is configured to slow down the flow of incoming air, for example to slow it from a supersonic flight speed to a subsonic flight speed, causing a conical shock wave to form at the apex of the air intake cone 2b. The air is then configured to flow through a gap defined between the air intake cone 2b and the outer casing 8 of the engine. Arranged downstream of the air intake arrangement 2 is a cylindrical annular heat exchanger 3 configured to cool air received by the air inlet 2a, and having a heat exchanger inlet 3i and a heat exchanger outlet 3o (see FIG. 2), with air being configured to flow from the inlet 3i to the outlet 3o generally inwardly along a radial direction of the engine 1. The heat exchanger 3 comprises a plurality of tubes (not shown) for the flow of a heat transfer medium therein, and air is configured to flow from the inlet 3i to the outlet 3o around and/or between said tubes to undergo heat exchange with the heat transfer medium.

As shown in FIG. 2, air is configured to flow along a first annular flow path 10 from the air inlet 2a to the heat exchanger inlet 3i. In this manner, the air is precooled by the heat exchanger 3 before then flowing to turbomachinery components 4, being directed into an inlet of the turbomachinery components 4 from a generally radial direction to a generally axial direction by a plurality of turning vanes 9 (see FIG. 2) configured to turn the air through approximately 90 degrees, before then flowing downstream to an augmentation system 5 (reheat/afterburner), a variable area nozzle 6 and then an exhaust 7 (see FIG. 1). The heat exchanger 3 is positioned in close proximity to the turbomachinery components 4 such that the two may be considered to be close-coupled, i.e. the aerodynamic flow field from the heat exchanger 3 influences the turbomachinery components 4, and the turbomachinery components 4 can have an upstream aerodynamic influence on the heat exchanger 3. For high Mach (e.g. above Mach 2.5) operation, the engine 1 also includes a ramjet, supplied by air that bypasses the turbomachinery components 4, and that can also optionally bypass the heat exchanger 3. At high Mach (e.g. above Mach 2.5), the ramjet will be the main thrust source. The ramjet can be run jointly with the turbomachinery components 4 during mode transition. The heat exchanger 3 can be used when the turbomachinery components 4 reach a material temperature limit, typically in a compression system 4a, as flight speed of the engine 1 increases. This would be in order to raise the maximum operational flight speed of the engine 1 at which the turbomachinery components 4 could be used.

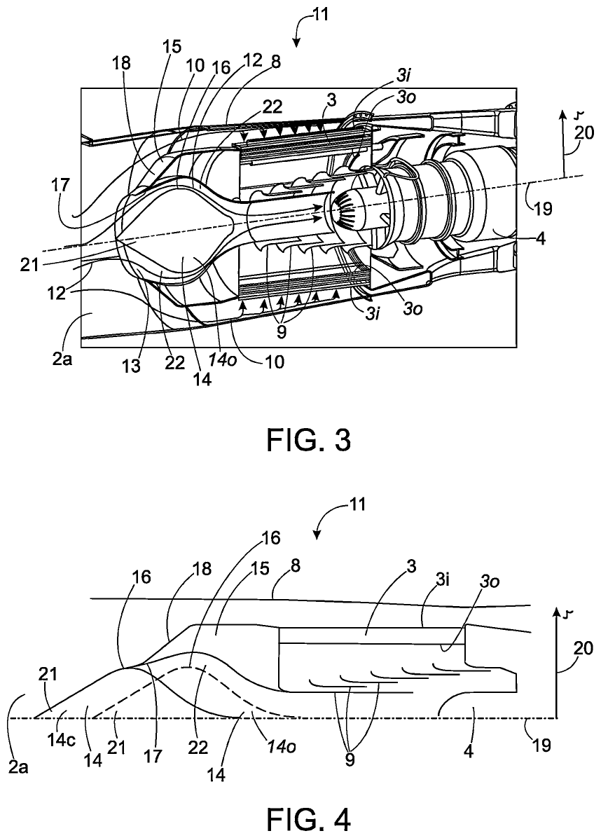

Alternative engines which comprise one or more additional means which can be used to supplement and/or replace the cooling action of a precooler heat exchanger, such as that of the precooler heat exchanger 3 shown in FIGS. 1 and 2, shall now be discussed, with reference to FIGS. 3 to 15. The exemplary engines described in relation to FIGS. 3 to 15 shall be discussed separately with a focus on their respective cooling arrangements. Though, it is to be understood that the engines described below may additionally include any one or more of the features of the engine 1 shown in FIG. 1, and may also include one or more optional additional and/or alternative features—i.e. one or more of said means for supplementing and/or replacing the cooling action of a precooling heat exchanger may be implemented together in the same engine and/or within the same heat exchanger arrangement. Such means can provide for more efficient air cooling in an engine by minimising pressure losses to achieve improved engine efficiency.

High Mach/hypersonic platforms are anticipated to employ precooled turbofan/jet engines for primary vehicle propulsion. A conventional turbofan or jet engine in isolation cannot typically reach hypersonic velocities due to the elevated enthalpy of the freestream flow causing the engine's operation to be restricted by practical limitations, such as a compressors' temperature limits. The use of a precooler (such as the heat exchanger 3) allows the inlet flow to be cooled such that the turbofan/jet may be run at both subsonic flight velocities and at velocities which are beyond its typical operating envelope. By extending this envelope to high Mach regimes, the propulsion system will then be able to undertake a mode transition whereby a ramjet is activated within the bounds of efficient space envelope and performance. This can provide a flexible operation since the engine may operate in any mode and also transition between them. In the exemplary precooled engine shown in FIGS. 1 and 2 and described above, all of the air entering the engine via the inlet is guided into the heat exchanger 3 to be precooled therein. This allows for maximum cooling of the incoming flow, but also imparts the greatest pressure loss on the flow. Such a turboramjet propulsion system does not require the precooler to protect the engine hardware at low aircraft Mach numbers, when the freestream flow enthalpy is low—i.e. at lower flight speeds, not all of the incoming airflow is required to be precooled. In these prior art configurations, the engine is typically operating at low altitudes where the air density and therefore the engine mass flow rate is high. This can lead to undesirable excessive pressure loss on the airflow at these conditions, leading to poor performance and inefficiency in the engine during take-off and during low flight speeds. The same applies to a precooled turbojet without a ramjet. To reduce this pressure loss, the examples described below in relation to FIGS. 2 to 15 provide a flow control arrangement 13 which can allow a portion of the air entering an engine to bypass the heat exchanger, such that only a portion of the incoming air is precooled. Similarly, the examples below described in relation to FIGS. 16 to 21 provide a flow control arrangement 13 which can allow a portion of the air entering an engine to bypass one heat exchanger of a modular heat exchanger arrangement, again such that only a portion of the incoming air is precooled.

FIG. 3 shows an alternative engine 11, which similarly to the engine 1, has an air inlet 2a configured to receive air into the engine 11, a cylindrical heat exchanger 3 having a heat exchanger inlet 3i and outlet 30, a plurality of turning vanes 9, and one or more turbomachinery components 4 arranged inside an outer casing 8. The heat exchanger inlet 3i is arranged downstream of the air inlet 2a, and the turbomachinery components 4 are arranged downstream of the heat exchanger outlet 30. In the example shown and described herein, the air intake arrangement of the engine 11 differs from that of the engine 1 in that the air intake cone is replaced with a flow control arrangement 13, to provide for a second flow path 12 in addition to the first flow path 10. Though, it is also envisaged that the engine 11 may alternatively in addition comprise a separate air intake arrangement separately to and upstream of the flow control arrangement 13 (for example an air intake cone 2b like in the example shown in FIG. 1 and described above, or any other axisymmetric air intake or a two dimensional air intake).

The flow control arrangement 13 includes an inner structure 14 comprising a generally conical upstream portion 21 having an apex, and an outer structure 15 that is generally annular and includes a tapered outer surface 18 that is generally in the form of a truncated cone. The inner structure 14 is movable relative to the outer structure 15 along the longitudinal axis 19 of the engine 11 and is arranged concentrically inside the outer structure 15. An actuator arrangement (not shown) is configured to control the movement of the inner and outer structures 14, 15 relative to one another, and may comprise, for example, one or more fueldraulic, hydraulic, pneumatic, ball-screw and/or electric actuators. In the example shown, the longitudinal axis 19 is generally linear, though it is also envisaged that said longitudinal axis may be at least partially curved. The inner structure 14 may be filled with a honeycomb filler material, or any other suitable filling means, to advantageously improve its mechanical stiffness. In the position shown in FIG. 3, which may be referred to as an “open” position 140 of the flow control arrangement 13, the inner and outer structures 14, 15 are positioned relative to one another such that there is provided an inlet flow aperture in the form of an annular gap 22 between the inner and outer structures 14, 15. The annular gap 22 is provided by the relative diameters and conical tapering of the shapes of the inner and outer structures 14, 15, and provides for a second flow path 12. It is envisaged that the size (for example the cross-sectional area) of the annular gap 22 may be chosen based on the proportion of the incoming air flow which it is desired to cause to bypass the heat exchanger arrangement 3. For example, a larger annular gap 22 may be chosen if it is desired for a larger proportion of the incoming air to bypass the heat exchanger arrangement 3 when the second flow path 12 is unobstructed. It is also envisaged that the gap 22 need to be an annular gap—any other suitable at least one flow aperture may be employed.

In this manner, when the flow control arrangement 13 is in the “open” position 140 (see FIG. 4), a first portion of air entering the engine 11 via the air inlet 2a can be caused to flow between the outer surface 18 of the outer structure 15 and the outer casing 8, along the first flow path 10, similarly to in the engine 1, flowing into and through the heat exchanger 3 generally inwardly (i.e. towards the longitudinal axis 19) along the radial direction 20 of the engine 1; whilst a second portion of air entering the engine 11 via the air inlet 2a can be caused to flow along the second flow path 12, via the annular gap 22. As an example, the first and second portions of air may comprise approximately 70% and 30% respectively of the air entering the engine 11 via the air inlet 2a. The second flow path 12 is arranged to extend from the air inlet 2a to the one or more turbomachinery components 4, through the hollow centre of the annular cylindrical heat exchanger 3 generally parallel to the longitudinal axis 19 of the engine 11, thus bypassing the heat exchanger inlet and outlet 3i, 3o, and hence not being precooled by the heat exchanger 3. As such, the first portion of air flowing along the first flow path 10 is configured to be precooled by the heat exchanger 3 before being delivered to the turbomachinery components 4, while the second portion of air flowing along the second flow path 12 is left uncooled before being delivered to the turbomachinery components 4.

Precooling only a portion of the air entering the engine 11 may be desirable at low Mach operation of the engine, when full precooling of all of the air flow is not needed, thus leading to a more efficient engine performance, by not doing any superfluous precooling, to advantageously reduce the total inlet pressure loss at lower flight speeds, such as at flight speeds between subsonic and approximately Mach 1.5.

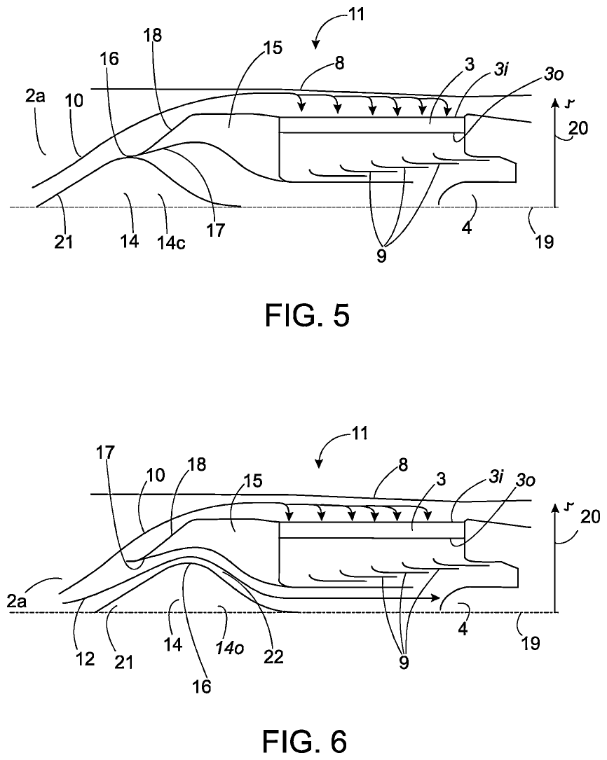

FIG. 4 shows that the inner structure 14 is also movable relative to the outer structure 15 into a “closed position” 14c, by moving the inner structure 14 along the longitudinal axis 19 in the upstream/forward direction, i.e. towards the air inlet 21. In this position, a portion of the inner structure 14 of maximum diameter 16 is arranged to bear against an inner surface 17 of the outer structure 15, such that the annular gap 22 is obstructed. In the closed position 14c, the inner and outer structures 14, 15 together form a generally continuous generally conical shaped structure, which is akin to the air intake cone 2b of the engine 1 (though it is also envisaged that the engine 11 may in addition also comprise a separate air intake arrangement upstream of the flow control arrangement 13, as discussed above), with no annular gap therein, to slow down the flow of incoming air received by the air inlet. In this manner, when the flow control arrangement 13 is in the “closed” position 14c, the second flow path 12 is blocked, meaning that when the engine 11 is in use, substantially all of the air entering the engine 11 via the air inlet 2a will be caused to flow along the first flow path 10 and thus to be precooled by the heat exchanger 3, because the second flow path 12 will be blocked off, thus not allowing for a portion of the air entering via the air inlet 2a to bypass the heat exchanger 3. FIGS. 5 and 6 show the flow control arrangement 13 in the “closed” 14c and “open” 14o positions respectively, to further illustrate the concept of how the relative movement of the inner and outer structures 14 selectively can provide for the annular gap 22 to selectively open up and obstruct the second flow path 12. It is also envisaged that the flow control arrangement 13 may be arrangeable in one or more intermediate positions been the open 14o and closed 14c positions, in which the second flow path 12 is partially obstructed.

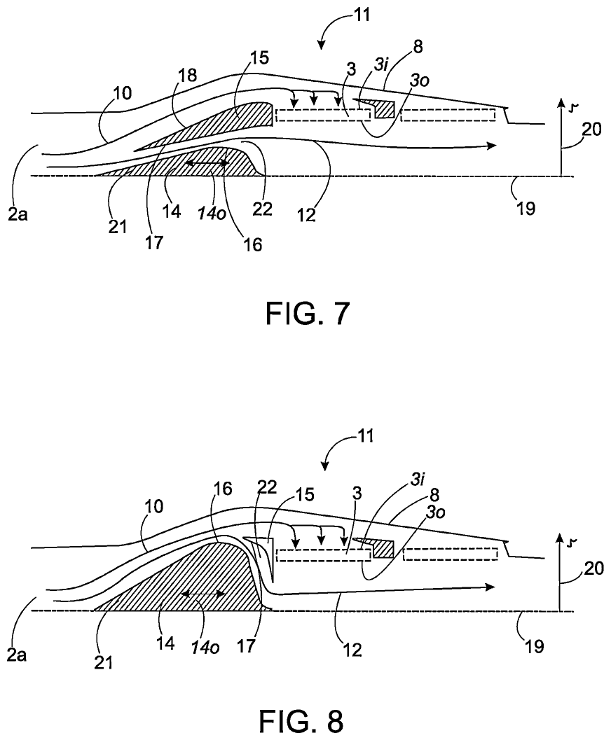

FIG. 7 shows an alternative example of the flow control arrangement 13 in which the inner and outer structures 14, 15 have a different shape to the example shown in FIGS. 3 to 6. The inner structure 14 is substantially conical and the apex of the conical portion 21 thereof is arranged upstream/forwards of the outer structure 15, which is in the form of a generally annular (i.e. hollow) conical shape. The inner surface/bore of the outer structure 15 has a diameter which corresponds to the diameter/shape of the inner structure 14, including the portion of maximum diameter 16.

In the examples shown in FIGS. 3 to 7, the inner structure 14 is configured to be axially moved towards the air inlet 2a (i.e. in the upstream/forwards direction) relative to the outer structure 15 to cause the portion of maximum diameter 16 to bear against the inner surface 17 of the outer structure 15 to obstruct the annular gap 22 and thus place the flow control arrangement 13 in the “closed” position 14c, in which the second flow path 12 is obstructed. Conversely, the inner structure 14 is configured to be axially moved away from the air inlet 2a (i.e. in the downstream/rearwards direction) relative to the outer structure 15 to provide the annular gap 22 and thus place the flow control arrangement 13 in the “open” position 14o in which the second flow path 12 is unobstructed. Though, it is also envisaged that the direction of movement required to move the flow control arrangement 13 between the “open” and “closed” positions 140, 14c may be reversed, such as in the example shown in FIG. 8, as described below.

In the example shown in FIG. 8, the portion of maximum diameter 16 of the inner structure 14, which is substantially conical, is arranged upstream/forwards of the entire outer structure which is generally annular. Also, the inner surface/bore of the outer structure 15 has a diameter which corresponds to the diameter/shape of the inner structure 14, including the portion of maximum diameter 16, such that in order to cause the portion 16 to bear against the inner surface 17 of the outer structure 15, the inner structure 14 is configured to be axially moved away from the air inlet 2a (i.e. in the downstream/rearwards direction) relative to the outer structure 15 to obstruct the annular gap 22 and thus place the flow control arrangement 13 in the “closed” position 14c in which the second flow path 12 is obstructed. Conversely, the inner structure 14 is configured to be axially moved towards the air inlet 2a (i.e. in the upstream/forwards direction) relative to the outer structure 15 into the “open” position 14o to cause a portion of the air received by the air inlet 2a to be able to flow along the second flow path 12.

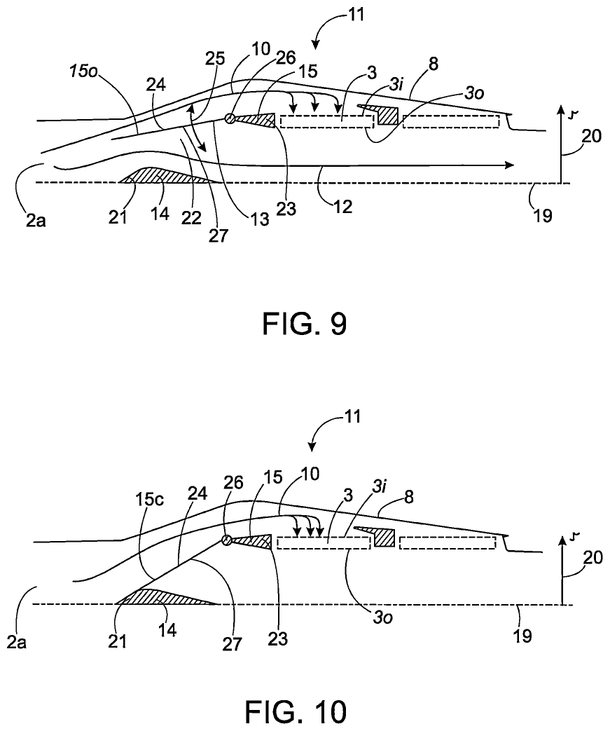

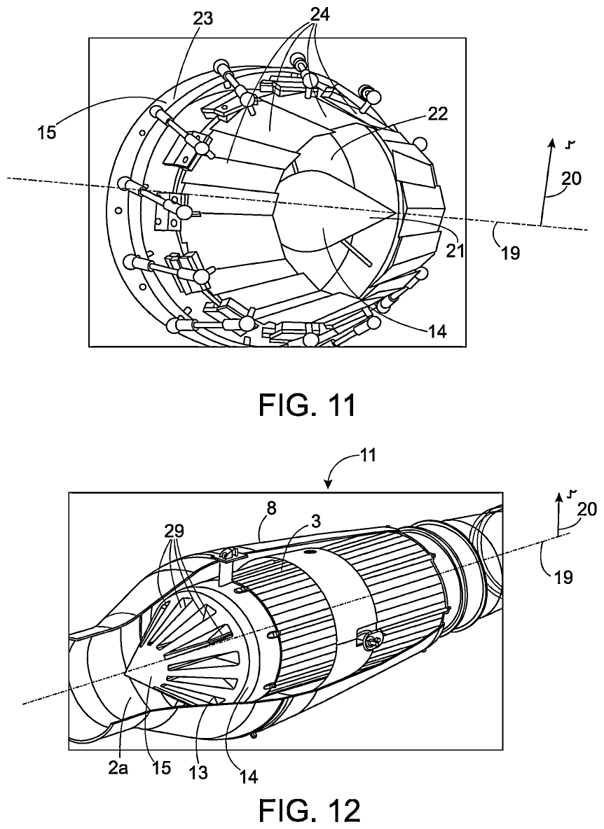

In an alternative example of a flow control arrangement 13 as shown in FIGS. 9 to 11, in which like reference numerals denote like elements, the inner structure 14 is configured to remain at a generally constant axial position along the longitudinal axis 19, whilst a portion of the outer structure 15 is configured to move relative to the inner structure 14. In this example, the outer structure 15 comprises an annular fixed structure 23 to which is connected one or more vanes 24. The vanes 24 are each in the form of a substantially flat plate or blade sized to bridge/span across the annular gap 22 when they are in at least one orientation/position (e.g. see FIG. 10, where the vanes 24 are shown in a closed position). As shown in FIG. 11, the one or more vanes 24 are arranged to be angularly spaced apart from one another about the longitudinal axis 19. The vanes 24 are each hingedly connected to the annular fixed structure 23 at a respective pivot point 26, such that they are configured to pivot relative to the inner structure 14 and the annular fixed structure 23, for example along the direction shown by the arrow 25, about each respective pivot point 26. In this manner, the vanes 24 are configured to be in an “open” position 150 (see FIG. 9) in which the annular gap 22 (see FIGS. 9 and 11) is provided between an inner surface 27 of the vanes 24 and the inner structure 14, to allow for a portion of the air received by the air inlet 2a to flow along the second flow path 12; and also to be in a “closed” position 15c (see FIG. 10) in which the annular gap 22 is obstructed by the inner surface 27 bearing against the inner structure 14 to obstruct the second flow path 12. Similarly to in the examples shown in FIGS. 3 to 8, when the flow control arrangement 13 is in the “closed position”, the inner and outer structures 14, 15 together form a generally continuous generally conical shaped structure, which is akin to the air intake cone 2b of the engine 1. Though, it is also envisaged that the engine 11 may alternatively in addition comprise a separate air intake arrangement separately to and upstream of the flow control arrangement 13 (for example an air intake cone 2b like in the example shown in FIG. 1 and described above, or any other axisymmetric air intake or a two dimensional air intake).

FIGS. 12 to 15 show another alternative example of a flow control arrangement 13, in which the inner structure 14 is arranged concentrically inside the outer structure 15, with both the inner and outer structures 14, 15 being generally conical, such that the inner structure 14 is nested within the outer structure 15 and its conical shape generally corresponds with that of the outer structure 15. The inner structure 14 includes a plurality of slots 28 angularly spaced apart from one another about the longitudinal axis 20. Similarly, the outer structure 15 also includes a plurality of slots 29 angularly spaced apart from one another about the longitudinal axis 20. The slots 28 and the slots 29 are shaped to correspond with other; for example each of the slots 28 may be the same size and shape as each of the slots 29. The inner structure 14 is configured to rotate about the longitudinal axis 20 relative to the outer structure 15 such that the slots 28 can be selectively lined up with the slots 29 by relative rotation therebetween. It is though envisaged that alternatively the outer structure 15 may be configured to rotate relative to the inner structure 14, or both the inner and outer structures 14, 15 may be configured to rotate about the longitudinal axis 20. The slots 28 and 29 may be sized and shaped to cover/extend over approximately half of the circumference or surface area of the inner structure 14 and the outer structure 15 respectively.

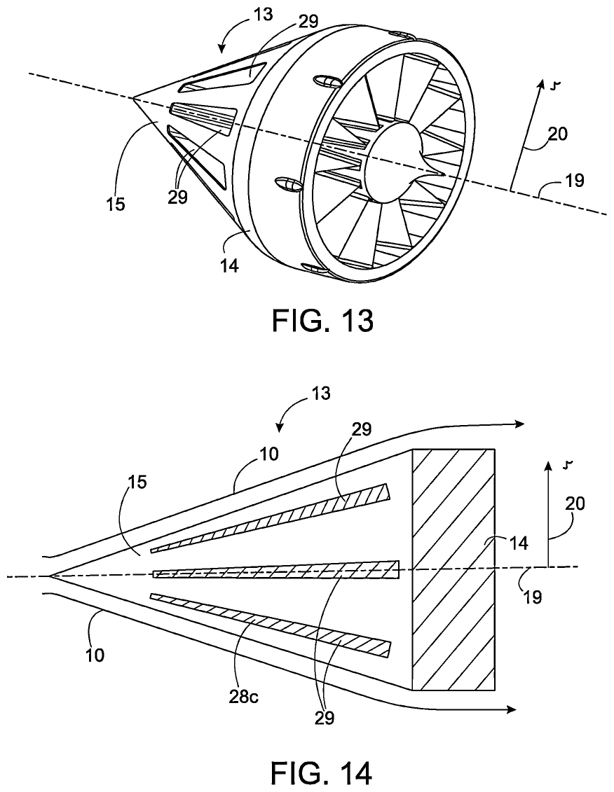

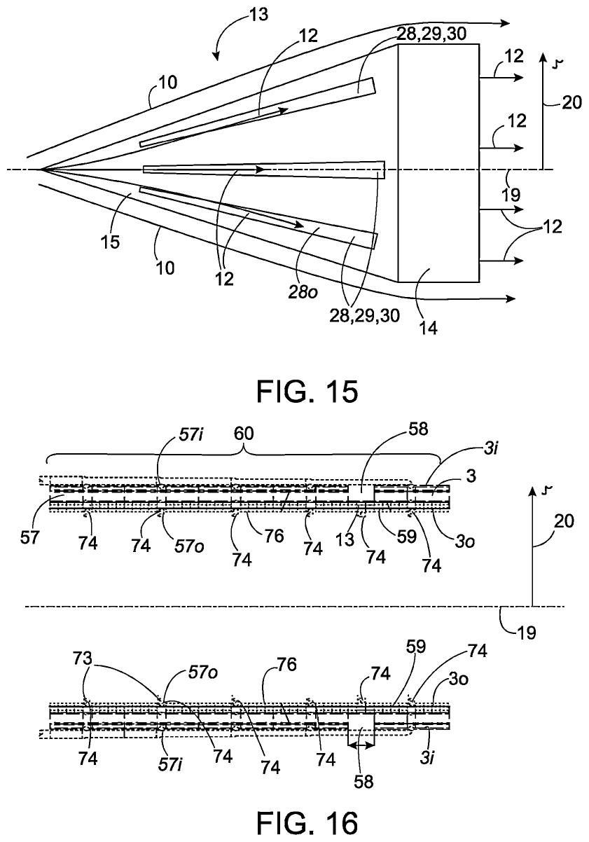

When the inner structure 14 is at a first rotational position relative to the outer structure 15 (see FIGS. 13 and 14), the slots 28 are arranged to be misaligned with the slots 29, such that the unslotted portions of the inner structure 14 bear against the slots 29 to block them off, to provide a “closed” position 28c of the flow control arrangement 13 in which the second flow path 12 is obstructed (see FIGS. 12 to 14). When the inner structure 14 is at a second rotational position relative to the outer structure 15 (see FIG. 15), the slots 28 are arranged to be lined up with the slots 29, such that the aligned slots 28, 29 provide for a plurality of inlet flow apertures 30 through the inner structure 14 and the outer structure 15, through which the second flow path 12 can extend, similar to the second flow path 12 extending through the annular gap 22 in the previously described example, to arrange the flow control arrangement 13 in an “open” position. In this manner, the rotation of the inner structure 14 relative to the outer structure 15 can provide for the second flow path 12 to be selectively obstructed, such that when the slots 28, 29 are lined up to provide the plurality of inlet flow apertures 30 through the inner and outer structures 14, 15, the second flow path 12 is not obstructed, so that at least a portion of air entering the engine from the air inlet 2a may be caused to flow along the second flow path 12, through the middle of the conical structure formed by the inner and outer structures 14, 15, to bypass the heat exchanger 3.

Although the exemplary heat exchanger 3 shown and described in relation to FIGS. 3 to 15 is a generally cylindrical annular heat exchanger configured for radial flow therethrough, it is also envisaged that the heat exchanger employed in the engine 11 may be any other suitable shape or form, for example it may be a segmented, conical or plate heat exchanger. Accordingly, it is envisaged that the flow control arrangement 13 may be used with any suitable heat exchanger and that the second flow path 12 may also be any other shape or trajectory to that shown in FIGS. 3, 4 to 10 and 15, as it may be tailored depending on the heat exchanger geometry. Similarly, it is to be understood that in order to provide for a second flow path 12 arranged to extend from the air inlet 2a to the one or more turbomachinery components 4, the at least one flow aperture need not necessarily be in the form of an annular gap 22 or a plurality of inlet flow apertures 30 as illustrated in the preceding examples: it is also envisaged that the at least one flow aperture may have any other suitable form through which the second flow path 12 may extend, and which may be selectively obstructed by the movement of the flow control arrangement 13. Additionally, it is envisaged that the inner structure 14 need not necessarily be movable relative to the outer structure 15 as in the examples depicted in FIGS. 3 to 8—alternatively, the outer structure 15 may be configured to be movable relative to the inner structure 14, and/or both the inner and outer structures 14, 15 may be configured to be movable relative to one another. The same reasoning also applies to the examples shown in FIGS. 9 to 15—it may be either or both of the inner structure 14 and the outer structure 15 that are configured to move relative to one another. Furthermore, whilst the above examples describe “open” and “closed” positions of the exemplary flow control arrangements 13, it is envisaged that the flow control arrangements 13 may also be configured to be arranged in one or more intermediate positions between the “open” and “closed” positions, wherein the second flow path 12 is partially but not fully/substantially blocked, to selectively increase and/or decrease the amount of air which may be permitted to flow along the second flow path 12. It is to be understood that while when in the “closed” position wherein the second flow path 12 is substantially or fully obstructed/blocked, in practice, during use of the engine 12, there may be a small amount of air entering the engine via the air inlet 2a which inadvertently leaks through the at least one inlet flow aperture (e.g. the annular gap 22 or the apertures 30) to flow along the second flow path 12. Whilst the above examples illustrate that the parts making up the flow control arrangement 13 may be movable relative to one another axially along the longitudinal axis 19, rotationally about said longitudinal axis 19, or pivotally, it is also envisaged that two or more of these movement directions may be combined, and/or that other movement directions may be utilised. For example, it is envisaged that the parts (e.g. inner and outer structures 14, 15) of the flow control arrangement 13 may be movable relative to one another both axially along and radially about the longitudinal axis 19, and/or that said parts may be movable relative to one another generally along the radial direction 20 of the engine 11.

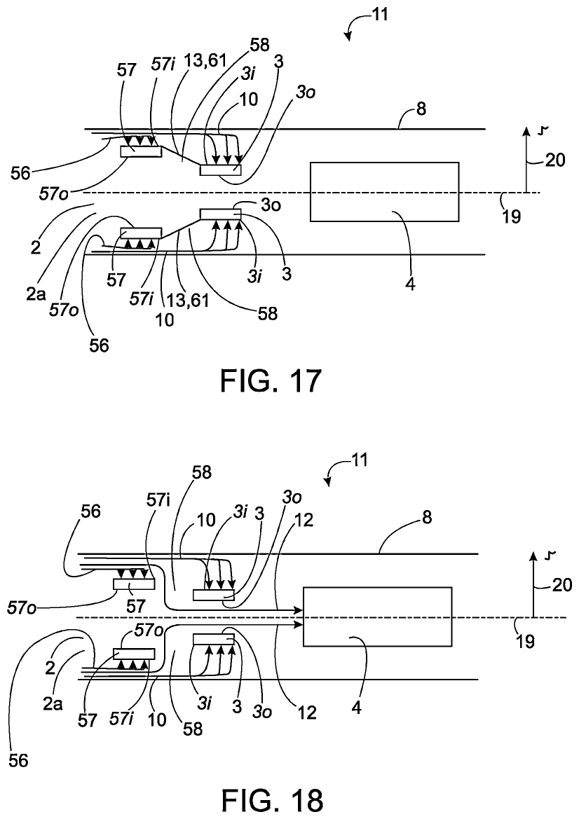

As shown in the alternative example of an engine 11 shown in FIGS. 17 and 18, and in FIG. 16 which illustrates an exemplary heat exchanger arrangement 3 thereof, it is also envisaged that a flow control arrangement 13 may be utilised in an engine 11 having a modular heat exchanger arrangement 60 comprising first and second annular heat exchangers 3, 57, which may be thought of as heat exchanger “modules”. The engine 11 shown in FIGS. 17 and 18 differs from those shown in FIGS. 3 to 15 in that the air intake arrangement 2 comprises an air intake cone (not shown), for example like that shown in FIGS. 1 and 2, for slowing down air received into the engine 11 by the air inlet, the air intake cone being separate from the flow control arrangement 13. In other words, in this example the flow control arrangement 13 has a different structural form, as described below, and does not also function as at least part of an air intake cone as part of the air intake arrangement. Similarly to in the engine 1 shown in FIGS. 1 and 2, the air intake cone is arranged upstream of the modular heat exchanger arrangement 60 and has an apex at which a conical shock wave is caused to form, thus slowing down the flow of incoming air entering the engine, before flowing around the cone inside of the outer casing 8. It is though also envisaged that any other suitable air intake arrangement may be employed, for example any other axisymmetric air intake, or a two dimensional air intake.

Like the first heat exchanger 3, the second heat exchanger 57 has an inlet 57i and an outlet 570. The first and second heat exchangers 3, 57 are spaced apart from one another along the longitudinal axis 19 of the engine 11 and are arranged with a gap 58 therebetween. The flow control arrangement 13 is arranged in the gap 58 and provides for selective bypassing of the first heat exchanger 3.

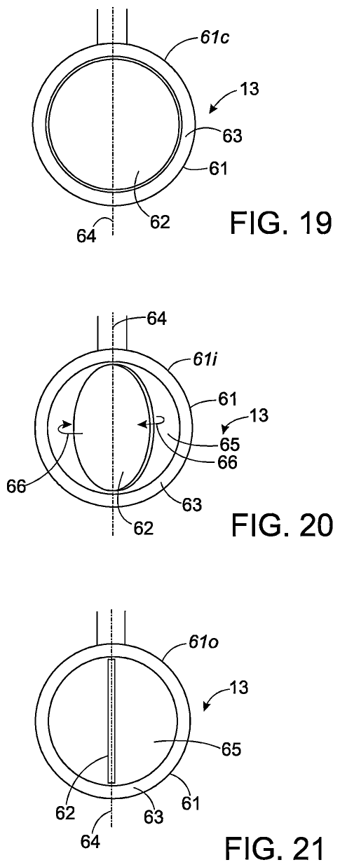

As shown in FIGS. 19 to 21, in this example, the flow control arrangement 13 comprises a plurality of butterfly valves 61 which are arranged to be angularly spaced apart from one another about the longitudinal axis 19 of the engine 11. Each of the butterfly valves 61 comprises a disc 62 which is rotatable about an axis 64 in a rotational direction 66 (see FIG. 20) relative to and within an annular fixed outer portion 63. In this manner, each of the butterfly valves 61 is movable between a closed position 61c (see FIG. 19) in which the disc is arranged to be generally planar with the outer portion 63; an open position 610 (see FIG. 21) in which the disc is arranged to be generally perpendicular to the outer portion 63 to provide an opening 65 therebetween; and at least one intermediate position 61i (see FIG. 20) therebetween. In this manner, when each of the butterfly valves is in a closed position 61c, the gap 58 is obstructed, as shown in FIG. 17. Conversely, when each of the butterfly valves is in an open 610 or intermediate 61i position, then at least a portion of the air received into the engine 11 by the air inlet 2a is permitted to flow through the gap 58 and hence to bypass the first heat exchanger 3. A cylindrical perforated drum structure 59 of the modular heat exchanger arrangement 60 bridges the gap 58 to provide structural support and allows for the passage of air therethrough, and the flow control arrangement 13 is attached to said drum structure 59.

Specifically, referring back to FIGS. 17 and 18, when the butterfly valves 61 are partially or fully open (see FIGS. 18, 20 and 21), a second flow path 12 arranged to extend from the air inlet 2a to the one or more turbomachinery components 4, bypassing the inlet 3i of the first heat exchanger 3, is left unobstructed. In the example shown in FIG. 18, the second flow path 12 has a first portion arranged to extend generally parallel to the longitudinal axis 19 between the outer housing 8 and the second annular heat exchanger 57; a second portion arranged to extend generally along the radial direction 20 through the gap 58; and a third portion arranged to extend generally parallel to said longitudinal axis 19 through the centre of the annular second heat exchanger 3. In the open 610, closed 61c and intermediate 61i positions of the butterfly valves 61, a first portion of air received by the air inlet 2a is permitted to flow into the first heat exchanger 3 along the first flow path 10 and a second portion of air received by the air inlet 2a is permitted to flow into the second heat exchanger 57 along a third flow path 56. Selective opening of the butterfly valves provides that a third portion of air received by the air inlet 2a may be permitted to bypass the first heat exchanger 3. This is advantageous because it means that the amount of incoming air flow being cooled overall by the modular heat exchanger arrangement 60 can be reduced.

Although in the embodiment shown in FIGS. 16 to 21, the flow control arrangement 13 comprises a plurality of butterfly valves 61, it is also envisaged that the flow control arrangement 13 may comprise any other suitable means. For example, the flow control arrangement 13 may comprise the cylindrical perforated drum structure 59 and a cylindrical perforated rotor configured to rotate relative to said perforated drum structure 59 and arranged concentrically inside the perforated drum structure 59, to selectively provide for one or more openings therethrough to un-obstruct the gap 58, similarly to the slotted cones shown in FIGS. 12 to 15 and described above.

An alternative means to cool air upstream of one or more turbomachinery components shall now be described. Bypass engines are a type of engine having one gas stream which passes through the core engine (i.e. the turbomachinery and combustion chamber), and another gas stream which bypasses the core engine (i.e. which flows around the turbomachinery and combustion chamber without being worked on therein). One property of such engines is that they have a bypass ratio (“BPR”), which is the ratio between the mass flow rate of the bypass stream to the mass flow rate entering the engine core, and which may typically be between 0.5 and 1. An engine having a BPR of greater than zero is a bypass engine. Bypass engines advantageously offer a good level of specific thrust whilst also offering a moderate specific fuel consumption. Using a precooler (a precooling heat exchanger arrangement) to cool the air entering an engine is one way to address the reduction in specific power/thrust typically observed at higher flight speeds in such engines. However, if a precooler is used with a bypass engine to cool all of the air flow entering the bypass engine, then as an example, for a BPR of between 0.5 and 1, around 30-50% of the heat transferred by the precooler (through the reduced air temperature) would be in air sent through the bypass (i.e. the gas stream which bypasses the engine core), with insignificant thrust benefit. In fact, at certain conditions where the use of an after burner is required, the lower temperature of precooled air would require more fuel flow to achieve a given/limiting afterburner flame temperature, thus deteriorating the fuel efficiency. This impact would be further exacerbated by an increase in forward speed of the aircraft as the engine needs to “throttle back” further to limit the high pressure compressor and turbine inlet temperatures. This “throttling back” would increase the operating BPR further and can effectively double the designed/intended BPR at high aircraft speeds (e.g. at higher Mach operation). This effect further dilutes the benefits of precooling all of the air entering the engine inlet, leading to inefficiencies in the overall engine operation.

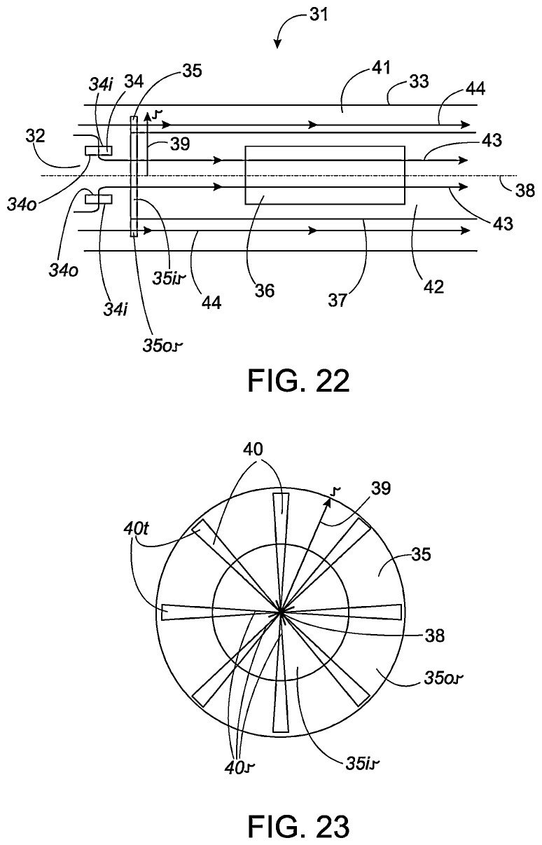

This effect of engine architecture can advantageously be mitigated significantly by the use of partial inlet air flow cooling, as described below in relation to FIGS. 22 to 28, which may also be referred to as “hub cooling” or “core only cooling”. Partial inlet air flow cooling advantageously enables the heat sink for the cooling system (nominally fixed by a limiting flow or heat capacity) to be directed more effectively at a part of the engine cycle that is causing specific thrust reduction/limitation, as forward engine/aircraft speed increases. This is because when using partial inlet air flow cooling as described herein, all of the heat and temperature reduction capability of the heat exchanger arrangement can be applied to/directed to the engine core (i.e. the core compression and combustion systems), such that only the air which really needs to be cooled (i.e. only a portion of the total air entering the engine) is cooled. That is, in operation of a bypass engine (i.e. an engine having a non-zero BPR) utilising partial inlet air flow cooling, the partial inlet air flow cooling predominantly cools the air flowing through the engine core, whilst leaving the outer bypass flow uncooled, resulting in improved engine efficiency. Exemplary such cooling arrangements shall be discussed below, and it is to be understood that these exemplary cooling arrangements may be used in addition to or instead of the cooling arrangements described above in relation to FIGS. 3 to 21. In addition, it is to be understood that although the above discussion focuses on bypass engines, it is also envisaged that partial inlet air flow cooling as described herein may also be employed with a non-bypass engine (i.e. an engine having a BPR of zero), to focus the cooling on a central hub section of the turbomachinery. This shall also be discussed below.

FIG. 22 shows an engine 31 having an air inlet 32, a first heat exchanger 34, a first low pressure compressor 35 and one or more turbomachinery components 36 arranged inside an outer casing 33 along and generally centred on a longitudinal axis 38 of the engine 31. In the example shown, the longitudinal axis 38 is generally linear, though it is also envisaged that said longitudinal axis may be at least partially curved. Between the one or more turbomachinery components 36 (which include a second high pressure compressor, a combustion chamber, and at least one turbine) and the outer casing 33, there is arranged a generally cylindrical inner casing 37. The gap 41 between the inner casing 37 and the outer casing 33 provides that a portion of the air entering the engine 31 from the air inlet 32 is able to bypass the one or more turbomachinery components 36 (i.e. the “engine core”), such that the engine 31 is a bypass engine and thus has a non-zero BPR. The remainder of the air entering the engine 31 from the air inlet 32 is able to flow through the engine core by conversely flowing inside the inner casing 37 through the gap 42. Although in the example shown the outer and inner casings 33, 37 are generally cylindrical, it is also envisaged that the outer and/or inner casings 33, 37 may be any other suitable shape.

In the example shown, the first heat exchanger 34 is generally annular such that air is configured to flow from its inlet 34i to its outlet 34o generally inwardly parallel to a radial direction 39 of the first low pressure compressor 35 that is generally perpendicular to the longitudinal axis 38, and is configured to cool a first portion of the air received by the air inlet 32, before said air is then compressed in the first low pressure compressor 35. It is though envisaged that the first exchanger 34 may have any other suitable form, for example it may be a conical and/or modular heat exchanger, or it may be a plate heat exchanger.

An outer radial portion 35 or of the compressor 35 that is generally annular is arranged further apart from the longitudinal axis 38 than an inner radial portion 35ir of the compressor 35 that is generally circular. As shown in FIG. 23, the compressor 35 comprises a plurality of blades 40 angularly spaced apart from one another and each arranged to extend from the centre of the compressor 35 at the longitudinal axis 38 outwards radially along the radial direction 39. Each of the blades has a respective tip 40t arranged in the outer radial portion 35or and a root 40r arranged in the inner radial portion 35ir. Referring back to FIG. 22, a first flow path 43 is arranged to extend from the air inlet 32 to one or more exhaust nozzles (not shown) downstream of the turbomachinery components/engine core 36 via the first heat exchanger 34 and the inner radial portion 35ir of the compressor 35. A second flow path 44 is arranged to extend from the air inlet 32 to said one or more exhaust nozzles via the outer radial portion 35or of the compressor 35, and bypassing the first heat exchanger 34 and the turbomachinery components/engine core 36. The first and second flow paths 43, 44 are arranged to extend generally parallel to the longitudinal axis 38, with at least a portion of the first flow path 43 being arranged in the gap 42 inside the inner casing 37, whilst at least a portion of the second flow path 44 is arranged in the gap 41 between the inner and outer casings 37, 33. In this manner, when the engine 31 is in operation, said first portion of air received into the engine 31 by the air inlet 32 is configured to flow along the first flow path 43 to be precooled in the first heat exchanger 34 before passing through the inner radial portion 35ir of the compressor 35 before flowing into the engine core 36, whilst a second portion of air received into the engine 31 by the air inlet 32 is configured to flow along the second flow path 44 without being precooled in the first heat exchanger 34, flowing downstream through the outer radial portion 35or of the compressor 35 and on to said one or more exhaust nozzles along the bypass stream in the gap 41. Accordingly, only the air entering the turbomachinery components/engine core 36 (i.e. said first portion of air) is precooled by the first heat exchanger 34. As discussed above, advantageously this enables the precooling action of the first heat exchanger 34 to be directed more effectively at the part of the engine's operating cycle that is causing specific thrust reduction/limitation, as the operational speed of the engine increases. This is because all of the heat and temperature reduction capability of the first heat exchanger 34 can advantageously be applied to/directed towards only to the engine core 36, such that only the air which really needs to be cooled (i.e. said first portion of air) is cooled, resulting in improved engine efficiency.

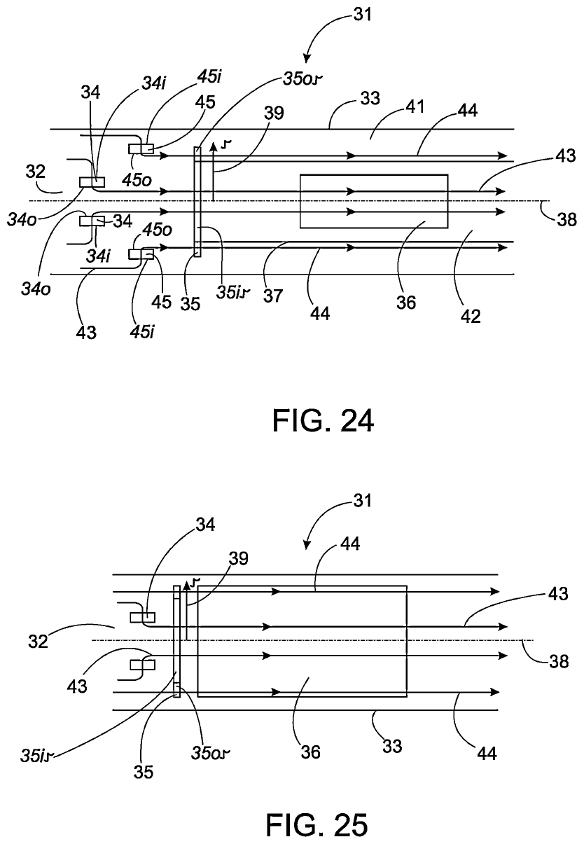

FIG. 24 shows an alternative example of the engine 31 which is substantially similar to the example shown in FIG. 22, but which further includes a second heat exchanger 45 arranged downstream of the first heat exchanger 34. Like the first exchanger 34, the second heat exchanger 45 is also generally annular such that air is configured to flow from its inlet 45i to its outlet 45o generally inwardly parallel to the radial direction 39, i.e. perpendicular to the longitudinal axis 38. Though, it is envisaged that the second heat exchanger 45 may also have any other suitable form. In the example shown, the first annular heat exchanger 34 is sized relative to the diameter of the inner radial portion 35ir of the first compressor 35 to provide for precooling of the first portion of air configured to flow along the first flow path 43, whilst the second annular heat exchanger 45 is sized to have a larger diameter than the first heat exchanger 34, to provide for precooling of the second portion of air configured to flow along the second flow path 44. That is, in the example shown in FIG. 24, the second flow path is arranged to extend through the second heat exchanger arrangement 45 before extending through the outer radial portion 35or of the compressor 35. In this manner, both the first and second portions of air can be precooled, i.e. both air flowing through the inner radial portion and the outer radial portion 35or of the compressor 35 may be cooled. The engine 31 further comprises a flow control arrangement (not shown), for example one or more valves and an actuator therefor, configured to selectively control the amount of a heat transfer medium flowing through the second heat exchanger 45, said heat transfer medium being configured to undergo heat transfer with the second portion of air to cool it. In this manner, the amount of a heat transfer medium flowing through the second heat exchanger 45 can be controlled to be selectively reduced relative to the amount of a heat transfer medium flowing through the first heat exchanger 34, and/or stopped entirely, to reduce the cooling capacity/effect of the second heat exchanger 45 compared with that of the first heat exchanger 34. This may be done at high flight speeds/low operational speeds of the engine 31, for example at above approximately Mach 1.5, by using the flow control arrangement selectively and/or in different modes of operation of the engine, to reduce the amount of precooling being performed on the second portion of air, or to entirely stop the second portion of air from being precooled. In the case of the latter, it is to be understood that the resulting effect on the second portion of air flowing along the second flow path 44 would be substantially the same as the effect on the second portion of air flowing along the second flow path 44 in the alternative example of FIG. 22. In the case of the former, it is to be understood that the first portion of air is thus configured to be cooled more than the second portion of air. Thus, in both cases (and also in the aforementioned other examples of partial inlet air flow cooling) the air flowing through the inner radial portion 35ir of the compressor 35 may be cooled more than the air flowing through the outer radial portion 35or. Advantageously, this can enable the precooling action of the first and/or second heat exchangers 34, 45 to be directed more efficiently at the part of the engine's operating cycle that is causing specific thrust reduction/limitation, as the operational speed of the engine increases, resulting in improved engine efficiency.

Furthermore, another advantage of the engines shown in FIGS. 22 to 24 and described above is that by cooling only the air which is configured to flow through the inner radial portion 35ir of the first compressor 35, leaving the air flowing through the outer radial portion 35or either uncooled or cooled to a lesser degree, this provides significant stress related benefits to the compressor 35, and especially to the roots 40r of its blades 40. This is because in general, keeping the inner radial portion 35i and hence also the blade roots 40r (i.e. a “hub section” of the compressor 35) cool will provide a significant advantage to the engine's turbomachinery, because the inefficiency of the compressor 35 would typically manifest itself in the flows along an inner wall of the compressor as high temperature with lower pressure, this area of the compressor 35 being where the rotating parasitic mass of the blades 40 meets a supporting/heavy thermally unresponsive disc/shaft (not shown) of the compressor 35. Thus, since the first compressor 35 is configured to operate across both the core steam (i.e. the first flow path) and the bypass stream (i.e. the second flow path), the concept of partial inlet air flow cooling thus provides an opportunity for the lower engine core air temperature to cool the compressor 35 itself, despite the outer radial portion 35or thereof being in a relatively higher temperature air flow. Thus, advantageously, the blades 40 can conduct heat away from the relatively hotter blade tips 40t towards the relatively cooler but more highly mechanically stressed blade roots 40r (i.e. from the radial outer portion 35or to the radial inner portion 35ir). Advantageously, the highly stressed hub section/radial inner portion 35ir of the compressor 35 which typically carries all the parasitic stress of the blades 40 may be running at a significantly cooler temperature. In turn, this may advantageously reduce the inlet temperature of a second high pressure compressor (not shown) in the engine core 36, thus allowing said second compressor to generate an increased pressure ratio (and hence an increased rise in temperature) and flow, thus increasing the specific thrust significantly more than if all of the inlet flow entering the engine 31 from the air inlet 32 were to be cooled in the heat exchanger 34. Furthermore, this will also serve to protect bearing chambers, rotating machinery discs and seals etc. in the engine 31 to a much greater extent than if the entire engine air inlet flow were to be cooled.

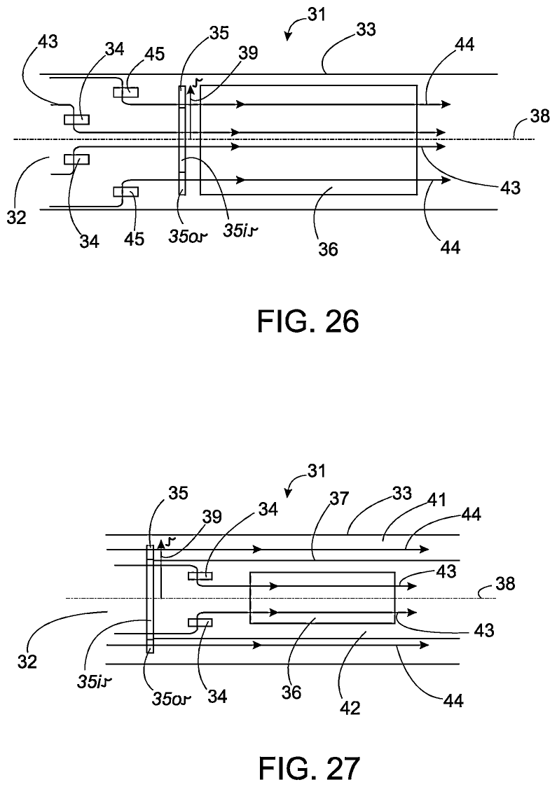

In light of the aforementioned significant mechanical and thermodynamic advantages, it is therefore envisaged that the concept of partial inlet air flow cooling may thus also be applied to non-bypass engines (i.e. engines having a BPR of zero), as discussed below in relation to FIGS. 25 and 26, to provide for cooling of their hub sections/inner radial portions/blade roots.

FIG. 25 shows an alternative example of the engine 31 which is substantially identical to the engine shown in FIG. 22 and described above, other than that there is no inner casing 37 so the engine is not a bypass engine, i.e. the engine shown in FIG. 25 has a BPR of zero, such that all of the air entering the engine 31 from the air inlet 32 is caused to flow through the turbomachinery components/engine core 36. In the example shown in FIG. 25, the second flow path 44 is arranged to extend through the turbomachinery components/engine core 36, though the second flow path 44 is still arranged to bypass the first heat exchanger 34 and flow through the outer radial portion 35or of the first heat exchanger 35, like in the example shown in FIG. 22. FIG. 25 thus illustrates that the concept of partial inlet air flow cooling may also be applied to non-bypass engines, to advantageously precool only a central portion of the air entering the engine 31, i.e. only the first portion of air which will pass through the inner radial portion 35ir of the compressor 35, to achieve the aforementioned stress and thermodynamic related benefits.

Similarly, FIG. 26 shows an alternative example of the engine 31 which is substantially identical to the engine shown in FIG. 24 and described above, other than that there is no inner casing 37 so the engine is not a bypass engine. The second flow path 44 is arranged to extend through the second heat exchanger 45, and the amount of a heat transfer medium flowing through the second heat exchanger can be selectively reduced or stopped entirely, like in the example shown in FIG. 24.

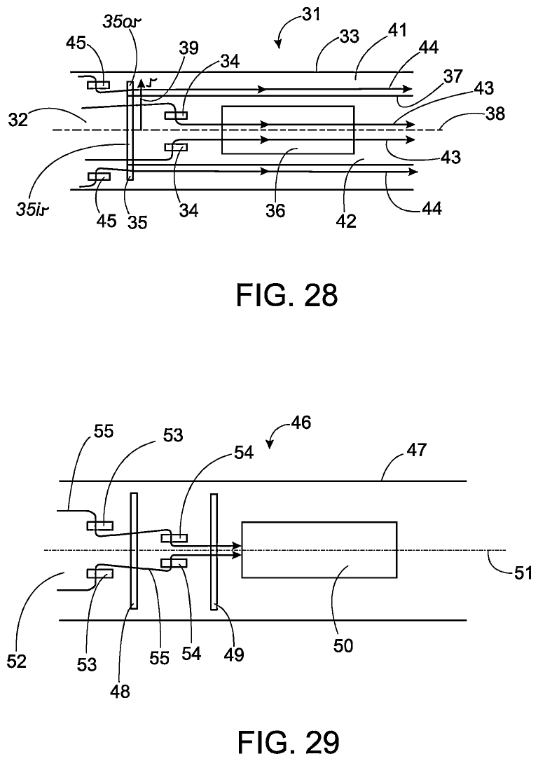

In the examples shown in FIGS. 22 to 26 and discussed above, the first heat exchanger 34 (and also the second heat exchanger 45, where applicable) is arranged upstream of the first compressor 35 such that the first heat exchanger 34 (and also the second heat exchanger 45, where applicable), cools the air before it is compressed by the first compressor 35, such that it may be thought of as a “precooler”. It is however also envisaged that the first and/or second heat exchangers 34, 45 may alternatively be arranged downstream of the first compressor 35 (but upstream of the turbomachinery components/engine core 36), as shown in FIGS. 27 and 28. In such a case, the first and/or second heat exchangers 34, 35 may be thought of as an “intercooler”. In the example shown in FIG. 27, the engine 31 is substantially identical to that shown in FIG. 22, other than that the first heat exchanger 34 is arranged downstream of the first compressor 35, such that the first portion of air flowing along the first flow path 43 is configured to be cooled (i.e. intercooled) after it has passed through the inner radial portion 35ir of the compressor 35. In the example shown in FIG. 28, the engine 31 is substantially identical to that shown in FIG. 24, other than that the first heat exchanger 34 is arranged downstream of the first compressor 35. It is also envisaged that the first and/or second heat exchangers 34, 45 may be arranged downstream of the first compressor 35 in a non-bypass engine (i.e. when the BPR is zero), such that the examples shown in FIGS. 25 and 26 may also be adapted to have their first and/or second heat exchangers 34, 45 arranged downstream of the first compressor 35. When the first and/or second heat exchangers 34, 35 are arranged downstream of the first compressor 35 to act as an “intercooler”, it is also envisaged that a third heat exchanger (not shown) may additionally be arranged upstream of the first compressor 35 to precool all or a portion of the air configured to flow through the compressor 35.

It is also envisaged that an intercooler may also be used with a precooler more generally, to cool all of the air flow, as shown in FIG. 29. The engine 46 shown in FIG. 29 has an outer casing 47 within which are arranged a first low pressure compressor 48, a second high pressure compressor 49, and one or more turbomachinery components 50 arranged along and generally centred on a longitudinal axis 51 of the engine 46. Arranged downstream of the air inlet 52 and upstream of the first low pressure compressor 48 is a first heat exchanger 53, which in the example shown is generally annular and is configured for radial flow therethrough, but which may also be any other suitable shape/configuration. Arranged downstream of the first low pressure compressor 48 and upstream of the second high pressure compressor 49 is a second heat exchanger 54, which in the example shown is also generally annular and configured for radial flow therethrough, but which may also be any other suitable shape/configuration. When the engine 46 is in use, substantially all of the air received by the air inlet 52 is configured to flow along a flow path 55 which is arranged to extend through both the heat exchangers 53, 54 and both the compressors 48, 49, before flowing downstream to the one or more turbomachinery components 50. In this manner, substantially all of the air flow entering the engine via the air inlet 52 is configured to be precooled by the first heat exchanger 53, and then to be intercooled by the second heat exchanger 54 between the two compression stages in the first and second compressors 48, 49. Advantageously, intercooling the air flow in the second heat exchanger 49 allows for the second high pressure compressor 49 to produce more work, by removing the waste heat from the first compression stage performed by the first low pressure compressor 48. Advantageously, performing both intercooling and precooling on the air flow (i.e. cooling the air both before and after the first compression stage) provides for reduced pressure losses, improved flexibility in operating the engine at different speeds, and improved overall engine efficiency. Although the example shown in FIG. 29 is a non-bypass engine, it is also envisaged that the concept of using both a precooler and an intercooler in an engine may also be applied to a bypass engine (i.e. an engine have a non-zero BPR). An example of this is shown in FIG. 28 and discussed above, in which an intercooler (the heat exchanger 34) is used to perform hub cooling downstream of a precooler (the heat exchanger 45).

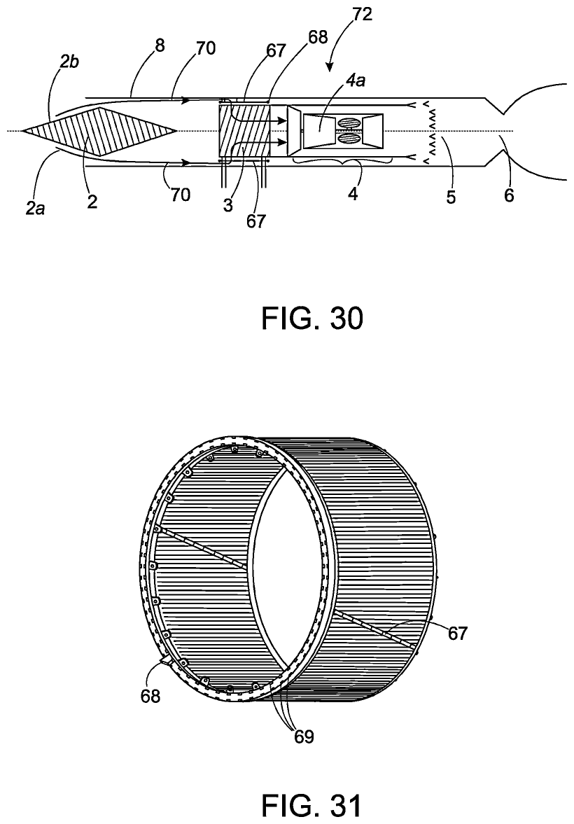

A means to supplement the cooling action of a heat exchanger shall now be described, with reference to FIGS. 30 to 33. This shall be described by way of example with reference to a precooler heat exchanger 3 as in the engine 1 shown in FIGS. 1 and 2 and described above, though it is to be understood that the foregoing teachings may also be applied to other heat exchangers or engines, such as the exemplary heat exchangers 3, 57, 34, 45, 53 and/or 54 as described above, or to any other heat exchanger.

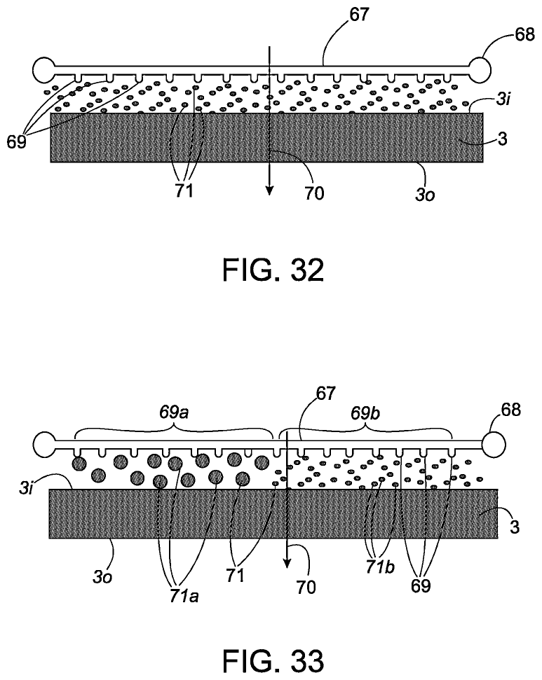

FIG. 30 shows an engine 72 which is similar to that shown in FIGS. 1 and 2 and has like elements (which are denoted using like reference numerals), differing from that shown in FIGS. 1 and 2 in that the engine 72 further comprises an injection arrangement 67 arranged downstream of the air inlet 2a. The injection arrangement 67 is generally annular (see FIG. 31) and is arranged concentrically between the heat exchanger 3 and the outer casing 8 of the engine 72. A first flow path 70 is arranged to extend from the air inlet 2a to the one or more turbomachinery components 4 via the inlet 3i and outlet 3o of the heat exchanger 3, to provide that substantially all of the air received into the engine 72 by the air inlet 2a is configured to be precooled in the heat exchanger 3 before it is delivered to the one or more turbomachinery components. The injection arrangement 67 comprises a plurality of injector nozzles 69 (see FIG. 32) for injecting droplets 71 of a liquid coolant supplied from a coolant supply 68 into the first flow path 70 at a location that is upstream of the one or more turbomachinery components 4. One or more valves (not shown) are used to control the supply of coolant into the injection arrangement 67, and are controlled by one or more actuators (not shown), such as an electric pump. It is envisaged that the individual injector nozzles 69 may be actuated independently to selectively “turn on” and “turn off” some of the injector nozzles 69, to control the supply and location of the droplets 71.

In the example shown in FIGS. 30 to 33, the injector nozzles 69 are arranged upstream of the heat exchanger inlet 3i such that the droplets 71 are introduced into the air flow in the first flow path 70 before said air flows through to be cooled in the heat exchanger 3. It is though envisaged that the injector nozzles 69 may be arranged/and or otherwise configured to inject the droplets 71 into the first flow path 70 at any other location along the first flow path 70, for example, inside a matrix of the heat exchanger 3 at a location between the inlet 3i and the outlet 3o, or downstream of the outlet 3o. It may be advantageous to arrange the injector nozzles 69 further upstream relative to the one or more turbomachinery components 4 (for example upstream of the inlet 3i, as in the present example), to increase the amount of time that the droplets 71 have to evaporate before the flow reaches the one or more turbomachinery components 4. In the example shown in FIGS. 31 and 32, the injector nozzles 69 are arranged to be spaced apart from one another relative to the longitudinal axis of the engine 72 and also to be angularly spaced about said longitudinal axis. In the example described herein, the coolant consists of water. Though, it is envisaged that any other fluid with a sufficiently high latent heat of vaporisation and specific heat may alternatively be used, for example, methanol, or a mixture or methanol and water. In addition, the injector nozzles 67 may further be configured to inject an antifreeze (for example, methanol) into the first flow path to prevent frost formation in and/or on the heat exchanger 3.

Advantageously, injecting droplets 71 of a liquid coolant (which in the example described herein consists of water, but which may be any other suitable coolant, for example methanol, or a mixture of water and methanol) into the first flow path upstream of the one or more turbomachinery components provides for improved cooling of the air, by supplementing/enhancing the precooling action of the heat exchanger 3. In particular, the droplets 71 will absorb heat from the air and will thus evaporate, in doing so, cooling the air. In other words, the vaporisation of the droplets 71 will cause a reduction in the air temperature. This is in addition to the cooling of the air that is achieved by placing said air into heat transfer with a heat transfer medium in the heat exchanger 3. This combination is particularly advantageous because if the injection arrangement 67 were to be used on its own to precool the air without the heat exchanger 3 also being present, then the mass of liquid coolant required to provide for sufficient air cooling would be significantly large, and this large mass could potentially negate the benefits of any such cooling, since in aerospace applications for example, it is highly desirable to minimise mass to achieve improved efficiency and reduce fuel consumption. Also, when using coolant injection alone to cool air, there may be difficulties in ensuring that all of the coolant evaporates in time before the air flow enters the one or more turbomachinery components.

By combining the injection arrangement 67 with the heat exchanger 3, advantageously it can thus aid the cooling action of the heat exchanger 3, and vice versa, to provide that the air flowing along the first flow path 70 is cooled as much as possible prior to ingestion in the one or more turbomachinery components 4. Since the heat exchanger 3 is also being used to perform some of said cooling, a lower mass of coolant is required for the injection arrangement 67. Also, the injection arrangement 67 can be used effectively to reduce the peak heat transfer requirement of the heat exchanger 3 by “peak-load loping”, thus enabling the heat exchanger 3 to be sized for more moderate heat transfer rates rather than for the peak heat transfer rate, thus reducing the size (and hence also the mass) of the heat exchanger 3. Furthermore, the combined use of the injection arrangement 67 with the heat exchanger 3 also enables operational flexibility of the engine 72, potentially allowing for high vehicle speeds to be accessed for short periods of time, when the engine 72 is applied in a vehicle, for example an aerospace vehicle.

It is desirable for the droplets 71 to evaporate by the time that the air flow reaches the one or more turbomachinery components 4. Injecting the droplets 71 into the first flow path 70 upstream of the heat exchanger inlet 3i is thus advantageous because the flow of air flow through the heat exchanger 3 is generally slower than the flow of air in the air intake arrangement 2, meaning that more time is available for the droplets 71 to evaporate. In the example described herein, the heat exchanger 3 comprises a plurality of tubes (not shown) for the flow of a heat transfer medium therein, and the air flowing along the first flow path 70 is configured to flow around and/or between said tubes, to undergo heat transfer with the heat transfer medium. Advantageously, when the droplets 71 are flowing from the heat exchanger inlet 3i to the heat exchanger outlet 30, they can strike the tubes, through inertial effects, causing the droplets 71 to break up and further slowing them down, thus encouraging and increasing the rate of their evaporation.

In the example shown in FIG. 32, all of the injector nozzles 69 are configured to inject droplets 71 that are generally of approximately equal size, and to inject said droplets 71 generally at approximately the same mass flow rate relative to one another. In the alternative example shown in FIG. 33, the injector nozzles 69 comprise a first set 69a of injector nozzles and a second set 69b of injector nozzles arranged downstream of the first set 69a. The second set 69b of injector nozzles is configured to inject droplets 71b of the liquid coolant into the first flow path 70 that have a smaller size than and/or a lower mass flow rate than droplets 71a injected into the first flow path 70 by the first set 69a of injector nozzles. In the example shown in FIG. 33, the first set of droplets 71a are larger than the second set of droplets 71b. This is advantageous because the larger droplets 71a are injected further upstream than the smaller droplets 71b, which means that they have more time to evaporate, to increase the chances of them evaporating by the time the flow reaches the one or more turbomachinery components, and to increase their cooling capability of the air. The smaller droplets 71b are injected further downstream, closer to the one or more turbomachinery components 4, so that their initial size and/or speed is smaller to increase the chances of them evaporating by the time the flow reaches the one or more turbomachinery components, since they have a shorter distance to travel. It is also envisaged that the size and/or mass flow rate of the droplets 71 along the upstream/downstream direction of the engine 72 may be varied in any alternative way, with the largest and/or highest mass flow rate droplets being further upstream, for example, with three sets of droplets getting successively smaller along the downstream direction. One or more valves (not shown) are used to control the supply of coolant into the injection arrangement 67, and are controlled by one or more actuators (not shown), such as an electric pump. It is envisaged that the individual injector nozzles 69 may be actuated independently to selectively “turn on” and “turn off” some of the injector nozzles 69, to control the supply and location of the droplets 71, and/or that the first set 69a of injector nozzles may be actuated together but separately from the second set 69b of injector nozzles to selectively provide for the first and second sets 71a, 71b of droplets 71.

A means to throttle air flowing through a heat exchanger shall now be described, with reference to FIGS. 16 and 41. This shall be described by way of example with reference to the modular heat exchanger arrangement 60 shown in FIG. 16. However, it is to be understood that the foregoing teachings outlining the concept of throttling the air flow through a heat exchanger may also be applied to other heat exchangers, such as the exemplary heat exchangers 3, 57, 34, 45, 53 and/or 54 as described above, or to any other modular or non-modular heat exchanger, for example a cylindrical or conical heat exchanger, a plate heat exchanger, a heat exchanger that is configured to act as a precooler, a heat exchanger that is configured to act as an intercooler, a heat exchanger that is configured to provide partial air inlet flow cooling, and/or a heat exchanger that is configured to operate together with an injection cooling arrangement.

It is also to be understood that while the example shown in FIG. 16 also shows a flow control arrangement 13 as described above, the throttling arrangement 73 described below may be employed independently of a flow control arrangement 13—i.e. they are distinct features which may be employed together and/or individually in any given heat exchanger.

As shown in FIG. 16, the modular heat exchanger arrangement 60 may further comprise a throttling arrangement 73, configured to be arranged upstream of one or more turbomachinery components (not shown) in an engine in which the modular heat exchanger 60 (or any other heat exchanger arrangement to which the throttling arrangement 73 is applied) is employed. In the example shown, the throttling arrangement 73 comprises a plurality of butterfly valves 74 arranged to be angularly spaced apart from one another about the longitudinal axis 19 in rows spaced apart from one another along said longitudinal axis 19. Though, it is envisaged that the throttling arrangement 73 may alternatively comprise any other suitable means for throttling air flow, for example any other type of valve.

In the example shown, the butterfly valves 74 are arranged adjacent to the heat exchanger outlets 3o, 57o in the bore 76 of the generally cylindrical/annular modular heat exchanger arrangement 60 and are attached to the cylindrical perforated drum structure 59. Though, it is also envisaged that the throttling arrangement 73 may be arranged at any other location upstream of said one or more turbomachinery components, for example within a matrix of a heat exchanger between its inlet and outlet, or upstream of the inlet of a heat exchanger.

The butterfly valves 74 may be similar to the butterfly valves 61 described above and shown in FIGS. 19 to 21, and are movable between a closed position, an open position, and at least one intermediate position therebetween. When the butterfly valves 74 are in the open position, the mass flow rate of air through the outlets 3o, 57o is greater than when the butterfly valves 74 are in the at least one intermediate position. This is because when the butterfly valves 74 are in the open position, the biggest possible opening therethrough is provided (this concept is illustrated in FIG. 21 for the similar butterfly valve 61), whereas when the butterfly valves 74 are in the at least one intermediate position, a smaller opening therethrough is provided (this concept is illustrated in FIG. 20 for the similar butterfly valve 61). One or more actuators (not shown) are configured to actuate the rotational movement of the butterfly valves 74. The butterfly valves 64 may be arranged in groups, each group being configured to be actuated independently of the other groups. For example, a first group of butterfly valves 64 associated with the heat exchanger 3 may be configured to be operated independently of a second group of butterfly valves 64 associated with the heat exchanger 57, to independently control the mass flow rate or air flow through the heat exchangers 3, 57 of the modular heat exchanger arrangement 60.

In this manner, the throttling arrangement 73 may be used to throttle the flow of air (i.e. to selectively reduce the mass flow rate of air) through the heat exchanger 3 and/or through the heat exchanger 57. That is, unless the butterfly valves 74 are completely closed, substantially all of the air received into the engine will be caused to flow into the heat exchanger inlets 3i, 57i such that substantially all of the air received into the engine is cooled by the heat exchanger 3 or the heat exchanger 57, but by varying the size of the opening through each of the butterfly valves 74, the mass flow rate of the air therethrough, and hence the mass flow rate of air through the heat exchangers 3, 57 can be reduced/controlled, i.e. throttled. This can be done to reduce the pressure mismatch in the engine to balance the pressure across the heat exchangers—i.e. by controlling the mass flow rate of the air flow, the pressure on either side of the butterfly valves 74 can be changed. Advantageously, this can allow the core engine to effectively operate at a lower pressure than the air intake arrangement. Also, when employed in a bypass engine (i.e. an engine having a non-zero BPR), this can allow the core engine to effectively operate at a lower pressure than the bypass system, thus permitting the bypass pressure to be increased to up to 1.9 bar, thereby increasing the bypass thrust at high Mach numbers whilst maintaining the non-dimensional operating point of a compressor in the engine constantly to modulate the flow therethrough, to achieve higher thrust at high Mach numbers/high flight speeds. The throttling arrangement 73 also permits deep throttling of the airbreathing engine at fixed non-dimensional conditions which could be useful for engine starting, ferry flights and aborts.

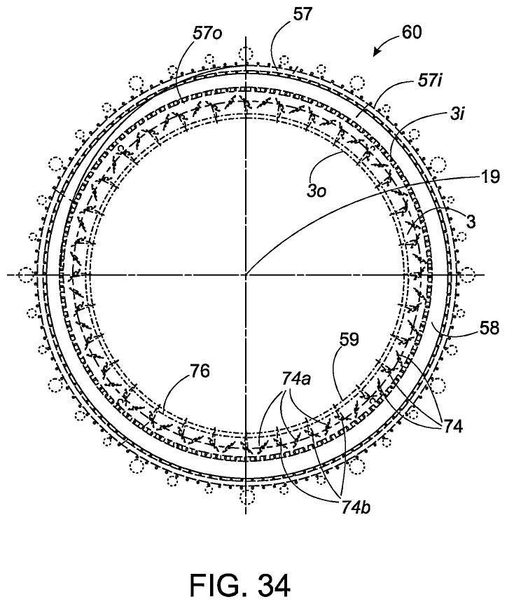

Referring now to FIG. 34, the butterfly valves 74 comprise a first set 74a and a second set 74b thereof. The first set of butterfly valves 74a are configured to be rotated in a first direction to provide for the opening and closing thereof. The second set of butterfly valves 74b are configured to be rotated in a second direction to provide for the opening and closing thereof, the second direction being opposite to the first direction. The first and second sets 74a, 74b of butterfly valves are arranged alternately with respect to one another about the longitudinal axis 19 of the engine. Advantageously, arranging alternate butterfly valves 74 to be configured to rotate in opposite directions can eliminate outlet swirl. It is though envisaged that the butterfly 74 valves, and in particular their rotational directions, may arranged in any other pattern/way relative to one another.

It should be understood that one or more of the aforementioned exemplary various means of performing/controlling air cooling in engines may be combined with one another. It should also be understood that the disclosure also includes an aircraft, flying machine or aerospace vehicle comprising any one or more of the exemplary engines and/or heat exchangers and/or air cooling means as described above.

Various modifications may be made to the described embodiment(s) without departing from the scope of the invention as defined by the accompanying claims.

1. An engine, comprising:
an air inlet configured to receive air;
a first heat exchanger arrangement arranged downstream of the air inlet, having a first heat exchanger inlet configured to receive at least a portion of the air received by the air inlet, and being configured to cool the air received by the first heat exchanger inlet;
one or more turbomachinery components arranged downstream of an outlet of the first heat exchanger arrangement, and being configured to receive air;
a first flow path arranged to extend from the air inlet to the first heat exchanger inlet;
a second flow path arranged to extend from the air inlet to the one or more turbomachinery components, the second flow path bypassing the first heat exchanger inlet;
and
a flow control arrangement comprising a first portion and a second portion, the first and second portions being configured to be movable relative to one another to selectively obstruct the second flow path.

2. An engine as claimed in claim 1, wherein said first and second portions are movable relative to one another to provide at least one inlet flow aperture into the second flow path upstream of the first heat exchanger inlet.

3. An engine as claimed in claim 2, wherein said first and second portions are configured to be movable relative to one another axially along a longitudinal axis of the engine, rotationally about said longitudinal axis and/or pivotally, to provide for said at least one inlet flow aperture.

4. An engine as claimed in claim 2 or claim 3, wherein said first and second portions are arranged concentrically relative to one another with respect to a longitudinal axis of the engine and are movable relative to one another along said longitudinal axis to provide for said at least one inlet flow aperture.

5. An engine as claimed in any of claims 2 to 4, wherein the at least one inlet flow aperture comprises an annular gap between the first and second portions.

6. An engine as claimed in claim 2 or claim 3, wherein said first portion comprises at least one vane configured to be pivotable relative to said second portion, in order to provide for the at least one inlet flow aperture.

7. An engine as claimed in claim 2 or claim 3, wherein said first and second portions are arranged concentrically relative to one another with respect to a longitudinal axis of the engine, the first portion comprising at least one first aperture and the second portion comprising at least one second aperture, the first and second portions being rotatable relative to one another about said longitudinal axis to align said at least one first aperture with said at least one second aperture to provide the at least one inlet flow aperture.

8. An engine as claimed in any of the preceding claims, wherein the first heat exchanger arrangement is generally annular, and the second flow path is arranged to extend generally parallel to a longitudinal axis of the engine through the centre of the generally annular first heat exchanger arrangement.

9. An engine as claimed in any of the preceding claims, wherein at least a portion of the first flow path is arranged between the flow control arrangement and an outer housing of the engine.

10. An engine as claimed in any of the preceding claims, wherein the flow control arrangement comprises at least a portion that is generally in the shape of a cone or a truncated cone and/or an axisymmetric curved shape.

11. An engine as claimed in any of claim 2, 3, 4 or 7, wherein the engine further comprises:
a second heat exchanger arrangement arranged upstream of the first heat exchanger arrangement, having a second heat exchanger inlet configured to receive at least a portion of the air received by the air inlet, and being configured to cool the air received by the second heat exchanger inlet; and
a third flow path arranged to extend from the air inlet to the second heat exchanger inlet;
wherein the at least one inlet flow aperture is positioned between the first and second heat exchanger arrangements.

12. An engine as claimed in claim 11, wherein the first and second heat exchanger arrangements are arranged to be spaced apart from one another along a longitudinal axis of the engine.

13. An engine as claimed in claim 11 or claim 12, wherein the flow control arrangement comprises at least one butterfly valve.

14. An engine as claimed in claim 12, or claim 13 when dependent on claim 12, wherein:
the first and second heat exchanger arrangements are generally annular and are arranged within an outer housing of the engine;
a first portion of the second flow path is arranged to extend generally parallel to the longitudinal axis of the engine between the outer housing and the second heat exchanger arrangement;
a second portion of the second flow path is arranged to extend generally perpendicular to said longitudinal axis in said gap between the first and second heat exchanger arrangements; and
a third portion of the second flow path is arranged to extend generally parallel to said longitudinal axis through the centre of the generally annular first heat exchanger arrangement.

15. A method of operating an engine as claimed in any one of claims 1 to 14, the method comprising:
causing air to flow along the first flow path such that at least a portion of the air received by the air inlet is cooled in the first heat exchanger arrangement by undergoing heat exchange with a heat transfer medium configured to flow through the first heat exchanger arrangement, before flowing downstream to the one or more turbomachinery components;
providing at least one actuating means for moving the first and second portions of the flow control arrangement relative to one another; and
using the at least one actuating means to move the first and second portions relative to one another to un-obstruct the second flow path, such that at least a portion of the air received by the air inlet is caused to flow along the second flow path, thus bypassing the first heat exchanger inlet.

16. An engine, comprising:
an air inlet configured to receive air;
a first compressor configured to receive air;
a first heat exchanger arrangement configured to cool air;
the first compressor and the first heat exchanger arrangement being arranged downstream of the air inlet and being arranged along and generally centred on a longitudinal axis of the engine, and the first compressor having a radial direction that is perpendicular to said longitudinal axis;
a first flow path arranged to extend through the first heat exchanger arrangement and an inner radial portion of the first compressor; and
a second flow path arranged to extend through an outer radial portion of the first compressor, the second flow path bypassing the first heat exchanger arrangement.

17. An engine as claimed in claim 16, wherein the engine further comprises one or more turbomachinery components configured to receive air and arranged downstream of the first compressor, and one or more exhaust nozzles arranged downstream of the one or more turbomachinery components; wherein the first and second flow paths are arranged to extend from the air inlet to the one or more exhaust nozzles.

18. An engine as claimed in claim 17, wherein the first flow path is arranged to extend through the one or more turbomachinery components, and the second flow path is arranged to bypass the one or more turbomachinery components.

19. An engine as claimed in any of claims 16 to 18, wherein the first compressor comprises a plurality of blades angularly spaced apart from one another and each arranged to extend generally along said radial direction, wherein each of the blades has a root and a tip, the root being arranged closer to said longitudinal axis than the tip, such that at least a portion of the first flow path is arranged to extend adjacent the roots of the blades, and at least a portion of the second flow path is arranged to extend adjacent the tips of the blades.

20. An engine as claimed in any of claims 16 to 19, wherein the first heat exchanger arrangement is arranged upstream of the first compressor.

21. An engine as claimed in claim 17 or claim 18, or claim 19 when dependent on claim 17 or claim 18, wherein the first heat exchanger arrangement is arranged downstream of the first compressor and upstream of the one or more turbomachinery components.

22. An engine as claimed in any of claims 16 to 21, wherein the engine further comprises a second heat exchanger arrangement configured to cool air arranged downstream of the air inlet and being arranged along and generally centred on said longitudinal axis;
wherein the second flow path is arranged to extend through the second heat exchanger arrangement; such that the first heat exchanger arrangement is configured to cool a first portion of air received by the air inlet, and the second heat exchanger arrangement is configured to cool a second portion of air received by the air inlet, the first portion of air being configured to flow along the first flow path, and the second portion of air being configured to flow along the second flow path.

23. An engine as claimed in claim 22, wherein the engine further comprises a flow control arrangement configured to selectively control the amount of a heat transfer medium flowing through the second heat exchanger arrangement for undergoing heat transfer with said second portion of the air.

24. An engine as claimed in any of claims 16 to 23, wherein the one or more turbomachinery components comprises a second compressor, at least one combustion chamber, and at least one turbine, the second compressor being configured to operate at a higher air pressure than the first compressor.

25. An engine as claimed in claim 24, wherein the first heat exchanger arrangement is arranged upstream of the second compressor.

26. An engine as claimed in claim 24 or claim 25, wherein the at least one combustion chamber comprises an air-breathing combustion chamber configured to receive compressed air from the second compressor and for the combustion of air and fuel, and a rocket combustion chamber for the combustion of fuel and oxidant, wherein the air-breathing combustion chamber and the rocket combustion chamber are configured to be operated independently.

27. An engine as claimed in any of claims 24 to 26, wherein the engine further comprises a ramjet.

28. A method of operating an engine as claimed in any one of claims 16 to 27, the method comprising:
causing air to flow along the first flow path such that at least a first portion of the air received by the air inlet is configured to flow adjacent the inner radial portion of the first compressor and is cooled in the first heat exchanger arrangement by undergoing heat transfer with a heat transfer medium configured to flow through the first heat exchanger arrangement; and
causing air to flow along the second flow path such that at least a second portion of the air received by the air inlet is configured to flow adjacent the outer radial portion of the first compressor and to bypass the first heat exchanger.

29. An engine, comprising:
an air inlet configured to receive air;
a first heat exchanger arrangement arranged downstream of the air inlet and configured to cool at least a portion of the air received by the air inlet;
a first compressor arranged downstream of the first heat exchanger arrangement and configured to receive and compress at least a portion of the air cooled by the first heat exchanger arrangement;
a second heat exchanger arrangement arranged downstream of the first compressor and configured to cool at least a portion of the air compressed by the first compressor; and
a second compressor arranged downstream of the second heat exchanger arrangement and configured to receive and compress at least a portion of the air cooled by the second heat exchanger arrangement, the second compressor being configured to operate at a higher air pressure than the first compressor.

30. An engine as claimed in claim 29, wherein the first and second heat exchanger arrangements and the first and second compressors are arranged along and generally centred on a longitudinal axis of the engine, and wherein the first and second heat exchanger arrangements are both generally annular and are configured for air to flow therethrough in a generally radial direction that is perpendicular to said longitudinal axis of the engine.

31. An engine as claimed in claim 30, wherein the first and/or second heat exchanger arrangements each comprises a plurality of heat exchanger modules arranged along said longitudinal axis of the engine.

32. A method of operating an engine as claimed in any one of claims 29 to 31, the method comprising:
causing air to enter the engine via the air inlet;
cooling at least a portion of the air received by the air inlet in the first heat exchanger arrangement using a first heat transfer medium;
compressing at least a portion of the air cooled by the first heat exchanger arrangement in the first compressor;
cooling at least a portion of the air compressed by the first compressor in the second heat exchanger arrangement using a second heat transfer medium; and
compressing at least a portion of the air cooled by the second heat exchanger arrangement in the second compressor.

33. An engine, comprising:
an air inlet configured to receive air;
a heat exchanger arrangement arranged downstream of the air inlet, the heat exchanger arrangement configured for the flow of a heat transfer medium therethrough to cool air;
one or more turbomachinery components arranged downstream of the heat exchanger arrangement and configured to receive air;
a first flow path for the flow of air through the engine, arranged to extend from the air inlet to the one or more turbomachinery components via an inlet and an outlet of the heat exchanger arrangement; and
an injection arrangement arranged downstream of the air inlet and comprising at least one injector nozzle configured to inject a liquid coolant into the first flow path upstream of the one or more turbomachinery components.

34. An engine as claimed in claim 33, wherein the coolant comprises water and/or methanol.

35. An engine as claimed in claim 33, wherein the coolant consists of water.

36. An engine as claimed in any of claims 33 to 35, wherein the injection arrangement is configured to inject the liquid coolant into the first flow path upstream of the heat exchanger outlet.

37. An engine as claimed in claim 36, wherein the injection arrangement is configured to inject the liquid coolant into the first flow path upstream of the heat exchanger inlet.

38. An engine as claimed in any of claims 33 to 37, wherein the heat exchanger arrangement comprises a plurality of tubes for the flow of the heat transfer medium therethrough, wherein the first flow path is arranged to extend around and/or between said tubes.

39. An engine as claimed in any of claims 33 to 36, wherein: the heat exchanger arrangement and the injection arrangement are both generally annular and are arranged along and generally centred on a longitudinal axis of the engine; at least a portion of the heat exchanger arrangement is arranged concentrically inside at least a portion of the injection arrangement; and the injection arrangement comprises a plurality of injector nozzles angularly spaced apart from one another relative to said longitudinal axis.

40. An engine as claimed in any of claims 33 to 39, wherein: the injection arrangement comprises at least one first injector nozzle and at least one second injector nozzle arranged downstream of the at least one first injector nozzle; the at least one first injector nozzle is configured to inject first droplets of the liquid coolant into the first flow path; and the at least one second injector nozzle is configured to inject second droplets of the liquid coolant into the first flow path that have a smaller size than and/or at a lower mass flow rate than the first droplets.

41. An engine as claimed in any of claims 33 to 40, wherein the at least one injector nozzle is further configured to inject an antifreeze into the first flow path.

42. An engine as claimed in any of claims 33 to 41, wherein the injection arrangement further comprises one or more valves arranged upstream of the at least one injector nozzle and configured to open and close to control the flow of the liquid coolant through the at least one injector nozzle.

43. An engine as claimed in claim 42, wherein the injection arrangement further comprises one or more actuators configured to actuate the opening and closing of the one or more valves.

44. A method of operating an engine as claimed in any one of claims 33 to 43, the method comprising:
causing air to flow along the first flow path such that at least a portion of the air received by the air inlet is cooled in the heat exchanger arrangement by undergoing heat exchange with the heat transfer medium, before flowing downstream to the one or more turbomachinery components; and
injecting the liquid coolant into the first flow path to supplement the cooling action of the heat transfer medium in the heat exchanger arrangement, to further cool at least a portion of said at least a portion of the air received by the air inlet before it flows downstream to the one or more turbomachinery components.

45. A method as claimed in claim 44, wherein the liquid coolant consists of water.

46. A method as claimed in claim 44 or claim 45, wherein the method further comprises actuating one or more valves arranged upstream of the at least one injector nozzle to control the flow of the liquid coolant through the at least one injector nozzle.

47. An engine, comprising:
an air inlet configured to receive air;
a heat exchanger arrangement configured downstream of the air inlet, the heat exchanger arrangement configured to cool at least a portion of the air received by the air inlet;
one or more turbomachinery components arranged downstream of the heat exchanger arrangement and configured to receive air; and
a throttling arrangement arranged upstream of the one or more turbomachinery components and configured to control the mass flow rate of air flow through the heat exchanger arrangement.

48. An engine as claimed in claim 47, wherein the throttling arrangement is arranged upstream of an outlet of the heat exchanger arrangement.

49. An engine as claimed in claim 48, wherein the throttling arrangement is arranged upstream of an inlet of the heat exchanger arrangement.

50. An engine as claimed in any of claims 47 to 49, wherein the throttling arrangement comprises one or more valves each configured to be movable into an open position, a closed position, and at least one intermediate position therebetween, to control the flow of air therethrough.

51. An engine as claimed in claim 50, wherein the one or more valves comprises a plurality of butterfly valves angularly spaced apart from one another relative to a longitudinal axis of the engine.

52. An engine as claimed in claim 51, wherein the plurality of butterfly valves comprises a first set of butterfly valves configured to be rotated in a first direction and a second set of butterfly valves configured to be rotated in a second direction that is opposite to the first direction, wherein the first and second sets of butterfly valves are arranged alternately with respect to one another about the longitudinal axis of the engine.

53. An engine as claimed in any of claims 50 to 52, wherein the throttling arrangement further comprises one or more actuators configured to actuate the movement of the one or more valves.

54. An engine as claimed in any of claims 47 to 53, wherein the heat exchanger arrangement is generally annular and is arranged along and generally centred on a longitudinal axis of the engine, and is configured for air to flow therethrough in a generally radial direction that is perpendicular to said longitudinal axis; and wherein the throttling arrangement is arranged on or adjacent a bore of the generally annular heat exchanger arrangement.

55. An engine as claimed in any of claims 47 to 54, wherein the heat exchanger arrangement comprises:
at least one fluid conduit section for the flow of a heat transfer medium therethrough, wherein said at least a portion of the air received by the air inlet is configured to flow around and/or between said at least one fluid conduit section; and
a support structure comprising a generally cylindrical perforated drum structure, to which the throttling arrangement is attached.

56. An engine as claimed in any of claims 47 to 55, wherein:
the heat exchanger arrangement comprises a plurality of heat exchanger modules; and
the throttling arrangement comprises a plurality of groups of valves each associated with one of the heat exchanger modules, wherein each of the groups of valves is configured to be actuated independently with respect to the other groups of valves, to independently control the mass flow rate of air flow through its respective heat exchanger module.

57. A method of operating an engine as claimed in any one of claims 47 to 56, the method comprising:
causing air to enter the engine via the air inlet;
causing at least a portion of the air received by the air inlet to flow downstream to be cooled in the heat exchanger arrangement by a heat transfer medium; and
actuating the throttling arrangement to control the mass flow rate of air flow through the heat exchanger arrangement.

58. An aircraft, flying machine or aerospace vehicle comprising an engine as claimed in any of claims 1 to 14, 16 to 27, 29 to 31, 33 to 43, or 47 to 56.
